(19) United States
(12) Patent Application Publication
(10) Pub. No.: US 2019/0322107 A1
(43) Pub. Date: Oct. 24, 2019

(54) Printing Apparatus and Head Unit

(71) Applicant: Seiko Epson Corporation, Tokyo (JP)

(72) Inventors: Kinya OZAWA, Shiojiri-Shi (JP); Seiichi TANIGUCHI, Asahi-Mura (JP); Hidenori USUDA, Matsumoto-Shi (JP); Yasumasa NAKAJIMA, Shiojiri-Shi (JP)

(21) Appl. No.: 16/467,484

(22) PCT Filed: Dec. 5, 2017
(86) PCT No.: PCT/JP2017/043686

§ 371 Date: Jun. 6, 2019

(30) Foreign Application Priority Data
Dec. 9, 2016 (JP) 2016-239653

(51) Int. Cl. B41J 11/00

(52) U.S. Cl. CPC B41J 11/002

(57) ABSTRACT

An object of the invention is to be capable of reducing occurrence of irradiation failure of a UV light source due to a mist of a UV ink.

A printing apparatus 1 includes: an ink discharge nozzle row 14 for discharging the UV ink; UV light sources 12 and 13 for emitting UV light for curing the UV ink; and a plasma actuator 20 that generates an airflow in a direction away from irradiated surfaces 12a and 13a of the UV light sources 12 and 13.

### TECHNICAL FIELD

The present invention relates to a printing apparatus and a head unit.

### BACKGROUND ART

In the related art, there is known a printing method in which a UV ink is discharged onto a printing medium, the UV ink is cured by irradiating the discharged UV ink with UV light from a UV light source, and the UV ink is fixed on the printing medium. In the printing method, a mist of the UV ink adheres to an irradiated surface of the UV light source, the mist of the UV ink is cured on the irradiated surface, and accordingly, there is a problem that a UV light amount emitted from the UV light source decreases and irradiation failure of the UV light source occurs.

Therefore, in the related art, a technique for wiping the mist of the UV ink that has adhered to the irradiated surface of the UV light source by wiping is disclosed (for example, refer to PTL 1).

### CITATION LIST

### Patent Literature

PTL 1: Japanese Unexamined Patent Application Publication No. 2009-178947

### SUMMARY OF INVENTION

### Technical Problem

However, in order to perform wiping similar to the related art, there is a problem that a large-scale apparatus is required between the irradiated surface of the UV light source and the printing medium, and the size of the printing apparatus itself increases.

The present invention has been made in view of the above-described circumstances, and an object thereof is to be capable of reducing occurrence of irradiation failure of a UV light source due to the mist of the UV ink.

### Solution to Problem

In order to solve the above-described problem, an ink discharge nozzle row for discharging a UV ink; a UV light source for emitting a UV light for curing the UV ink; and a plasma actuator that generates an airflow in a direction away from an irradiated surface of the UV light source, are provided.

According to the present invention, since the plasma actuator generates the airflow in the direction away from the irradiated surface of the UV light source, mist of the UV ink becomes unlikely to adhere to the irradiated surface of the UV light source, and it is possible to reduce occurrence of the irradiation failure of the UV light source due to the mist of the UV ink. Further, by providing the plasma actuator, there is no need to provide a large-scale apparatus, such as an apparatus for wiping, and equipment cost can be reduced.

In addition, in the present invention, the plasma actuator is disposed between the ink discharge nozzle row and the UV light source.

According to the present invention, since the plasma actuator is disposed between the ink discharge nozzle row and the UV light source, it is possible to generate the airflow between the ink discharge nozzle row and the UV light source by the plasma actuator, the mist of the UV ink becomes unlikely to adhere to the irradiated surface of the UV light source, and it is possible to reduce occurrence of the irradiation failure of the UV light source due to the mist of the UV ink.

In addition, in the present invention, an ink jet head that is mounted on a carriage that reciprocates in a direction intersecting with a transport direction of a printing medium and has the ink discharge nozzle row, is further provided.

According to the present invention, in the ink jet head mounted on the carriage that reciprocates in the direction intersecting with the direction in which the printing medium is transported, since the plasma actuator generates the airflow in the direction away from the irradiated surface of the UV light source, the mist of the UV ink becomes unlikely to adhere to the irradiated surface of the UV light source, and it is possible to reduce occurrence of the irradiation failure of the UV light source due to the mist of the UV ink.

In addition, in the present invention, the plasma actuator is disposed side by side with the ink discharge nozzle row in a moving direction of the carriage.

According to the present invention, since the plasma actuator is disposed side by side with the ink discharge nozzle row in the moving direction of the carriage, the mist of the UV ink discharged from the ink discharge nozzle row disposed in the moving direction of the carriage becomes unlikely to adhere to the irradiated surface of the UV light source, and it is possible to reduce occurrence of the irradiation failure of the UV light source due to the mist of the UV ink.

Further, the present invention includes a plurality of the plasma actuators that are disposed to interpose the ink discharge nozzle row therebetween.

According to the present invention, since the plurality of plasma actuators that are disposed to interpose the ink discharge nozzle row therebetween are provided, the mist of the UV ink becomes unlikely to adhere to the irradiated surface of the UV light source regardless of the moving direction of the carriage, and it is possible to reduce occurrence of the irradiation failure of the UV light source due to the mist of the UV ink.

In addition, in the present invention, the plasma actuator generates the airflow in a discharge direction in which the ink discharge nozzle row discharges the UV ink.

According to the present invention, since the plasma actuator generates the airflow in the discharge direction in which the ink discharge nozzle row discharges the UV ink, it is possible to form an air curtain between the ink discharge nozzle row and the UV light source, the mist of the UV ink becomes unlikely to adhere to the irradiated surface of the UV light source, and it is possible to reduce occurrence of the irradiation failure of the UV light source due to the mist of the UV ink.

In addition, in the present invention, an ink jet head having the ink discharge nozzle row that extends in a direction intersecting with a transport direction of a printing medium, is further provided.

According to the present invention, in the ink jet head having the ink discharge nozzle row that extends in a direction intersecting with the transport direction of the printing medium, since the plasma actuator generates the airflow in the direction away from the irradiated surface of the UV light source, the mist of the UV ink becomes unlikely to adhere to the irradiated surface of the UV light source, and it is possible to reduce occurrence of the irradiation failure of the UV light source due to the mist of the UV ink.

In addition, in the present invention, the plasma actuator is disposed side by side with the ink discharge nozzle row in the transport direction of the printing medium.

According to the present invention, since the plasma actuator is disposed side by side with the ink discharge nozzle row in the transport direction of the printing medium, the mist of the UV ink discharged from the ink discharge nozzle row disposed in the transport direction of the printing medium becomes unlikely to adhere to the irradiated surface of the UV light source, and it is possible to reduce occurrence of the irradiation failure of the UV light source due to the mist of the UV ink.

In addition, in the present invention, the plasma actuator generates the airflow in a discharge direction in which the ink discharge nozzle row discharges the UV ink.

According to the present invention, since the plasma actuator generates the airflow in the discharge direction in which the ink discharge nozzle row discharges the UV ink, the air curtain is formed between the ink discharge nozzle row and the UV light source, the mist of the UV ink becomes unlikely to adhere to the irradiated surface of the UV light source, and it is possible to reduce occurrence of the irradiation failure of the UV light source due to the mist of the UV ink.

In addition, in the present invention, a rotary drum for transporting the printing medium is further provided, and the plasma actuator generates the airflow in a direction opposite to a rotational direction in which the drum rotates.

According to the present invention, in a configuration in which the rotary drum that transports the printing medium is provided, since the plasma actuator generates the airflow in the direction opposite to the rotational direction in which the drum rotates, the mist of the UV ink becomes unlikely to adhere to the UV light source, and it is possible to reduce occurrence of the irradiation failure of the UV light source due to the mist of the UV ink.

In addition, in the present invention, the ink discharge nozzle row includes a first ink discharge nozzle row for discharging a background image printing UV ink for printing a background image and a second ink discharge nozzle row for discharging a main image printing UV ink for printing a main image, the UV light source includes a first UV light source for curing the background image printing UV ink and a second UV light source for curing the main image printing UV ink, and the plasma actuator is disposed between the first ink discharge nozzle row and the first UV light source and between the second ink discharge nozzle row and the second UV light source.

According to the present invention, since the plasma actuator is disposed between the first ink discharge nozzle row and the first UV light source and between the second ink discharge nozzle row and the second UV light source, the mist of the background image printing ink becomes unlikely to adhere to the irradiated surface of the UV light source for curing the background image printing ink, the mist of the main image printing ink becomes unlikely to adhere to the irradiated surface of the UV light source for curing the main image printing ink, and it is possible to reduce occurrence of the irradiation failure of the UV light source due to the mist of the each UV ink.

In addition, in the present invention, the plasma actuator disposed between the first ink discharge nozzle row and the first UV light source generates the airflow having a larger air volume than that of the airflow generated by the plasma actuator disposed between the second ink discharge nozzle row and the second UV light source.

According to the present invention, since the plasma actuator disposed between the first ink discharge nozzle row and the first UV light source generates the airflow having a larger air volume than that of the airflow generated by the plasma actuator disposed between the second ink discharge nozzle row and the second UV light source, the mist of the background image printing UV ink becomes unlikely to adhere to the UV light source for curing the background image printing UV ink and the UV light source for curing the main image printing UV ink, and it is possible to reduce occurrence of the irradiation failure of the UV light source due to the mist of the background image printing UV ink.

In addition, in the present invention, a head unit having a driving voltage generation unit that generates a driving voltage for driving the plasma actuator, and the ink discharge nozzle row, is further provided.

According to the present invention, it is possible to generate a driving voltage to the plasma actuator driven with a high voltage by the driving voltage generation unit. Therefore, it is unnecessary to lay a high voltage wiring on a flexible cable, and problems, such as insulation, short-circuiting measures, noise countermeasures, and the like, do not occur.

In addition, in the present invention, a UV light source unit having a driving voltage generation unit that generates a driving voltage for driving the plasma actuator, and the UV light source, is further provided.

According to the present invention, it is possible to generate a driving voltage to the plasma actuator driven with a high voltage by the driving voltage generation unit. Therefore, it is unnecessary to lay a high voltage wiring on a flexible cable, and problems, such as insulation, short-circuiting measures, noise countermeasures, and the like, do not occur.

In addition, in the present invention, a length of the plasma actuator is longer than a length of the irradiated surface of the UV light source.

According to the present invention, the mist generated from the ink discharge nozzle row becomes unlikely to adhere to the irradiated surface of the UV light source, and it is possible to reduce occurrence of irradiation failure of the UV light source due to the mist of the UV ink.

In addition, in the present invention, the length of the plasma actuator is longer than a length of the ink discharge nozzle row.

According to the present invention, the mist generated from the ink discharge nozzle row becomes unlikely to adhere to the irradiated surface of the UV light source, and it is possible to reduce occurrence of irradiation failure of the UV light source due to the mist of the UV ink.

In order to solve the above-described problem, a head unit of the present invention includes: an ink discharge nozzle row for discharging a UV ink; a UV light source for emitting a UV light for curing the UV ink; and a plasma actuator that generates an airflow in a direction away from an irradiated surface of the UV light source.

According to the present invention, since the plasma actuator generates the airflow in the direction away from the irradiated surface of the UV light source, the mist of the UV ink becomes unlikely to adhere to the irradiated surface of the UV light source, and it is possible to reduce occurrence of the irradiation failure of the UV light source due to the mist of the UV ink. Further, by providing the plasma actuator, there is no need to provide a large-scale apparatus, such as an apparatus for wiping, and equipment cost can be reduced.

### BRIEF DESCRIPTION OF DRAWINGS

FIG. 1 is a view illustrating an outline of a printing apparatus according to a first embodiment.

FIG. 2 is a schematic view of a head unit of the printing apparatus.

FIG. 3 is a schematic view from an ink discharge surface side of FIG. 2.

FIG. 4 is a sectional view illustrating a basic structure of a plasma actuator.

FIG. 5 is a view illustrating a modification example of disposition of the plasma actuators.

FIG. 6 is a view illustrating a modification example of disposition of the plasma actuators.

FIG. 7 is a view illustrating a modification example of an airflow generated by the plasma actuators.

FIG. 8 is a block diagram illustrating a functional configuration of the printing apparatus.

FIG. 9 is a view illustrating an outline of a printing apparatus according to a second embodiment.

FIG. 10 is a schematic view from an ink discharge surface side of FIG. 9.

FIG. 11 is a view illustrating an outline of the printing apparatus.

FIG. 12 is a schematic view from an ink discharge surface side of FIG. 11.

FIG. 13 is a view illustrating an outline of a printing apparatus according to a third embodiment.

FIG. 14 is a view illustrating an outline of the printing apparatus.

### DESCRIPTION OF EMBODIMENTS

### First Embodiment

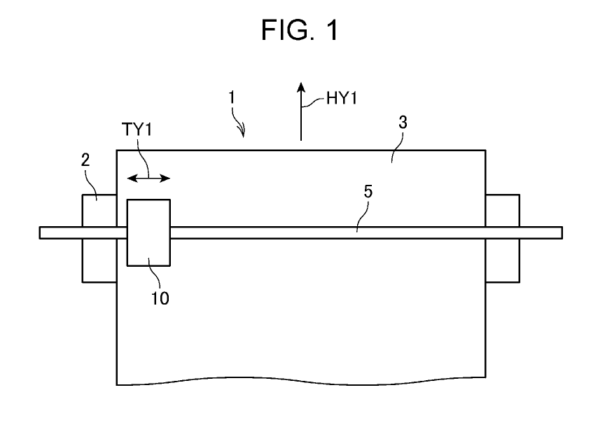

FIG. 1 is a schematic view of a printing apparatus 1 according to a first embodiment.

As illustrated in FIG. 1, the printing apparatus 1 is provided with a flat platen 2. A predetermined printing medium 3 is transported to an upper surface of the platen 2 in a transport direction HY1 by a paper feed mechanism (not illustrated). The platen 2 may be provided with an ink abandoning region during marginless printing.

Examples of the printing medium 3 include a roll paper sheet wound in a roll shape, a cut sheet cut to a predetermined length, and a continuous sheet to which a plurality of sheets are connected to each other. The printing media are a plain paper sheet, a paper sheet, such as a copying paper sheet or a thick paper sheet, and a sheet, such as a sheet made of synthetic resin, and the sheets which have been subjected to processing, such as coating or infiltration, can also be used. In addition, a form of the cut sheet, for example, in addition to a regular size cut paper sheet, such as a PPC paper sheet or a postcard, a form of a booklet in which a plurality of sheets, such as passbooks, are bound, or a form formed into a bag shape, such as an envelope, can be employed. Further, as a form of a continuous sheet, for example, a continuous paper sheet folded at a predetermined length can be employed, in which sprocket holes are formed at both ends in a width direction.

Above the platen 2, a guide shaft 5 that extends in a direction TY1 (intersecting direction) orthogonal to the transport direction HY1 of the printing medium 3 is provided. A carriage 10 is provided on the guide shaft 5 so as to freely reciprocate along the guide shaft 5 via a driving mechanism (not illustrated). In other words, the carriage 10 reciprocates along the guide shaft 5 in the direction TY1 orthogonal to the transport direction HY1.

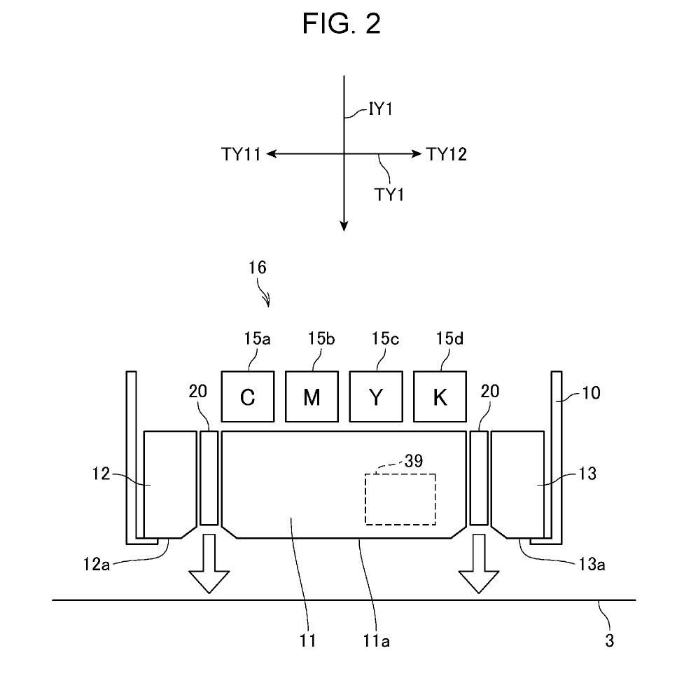

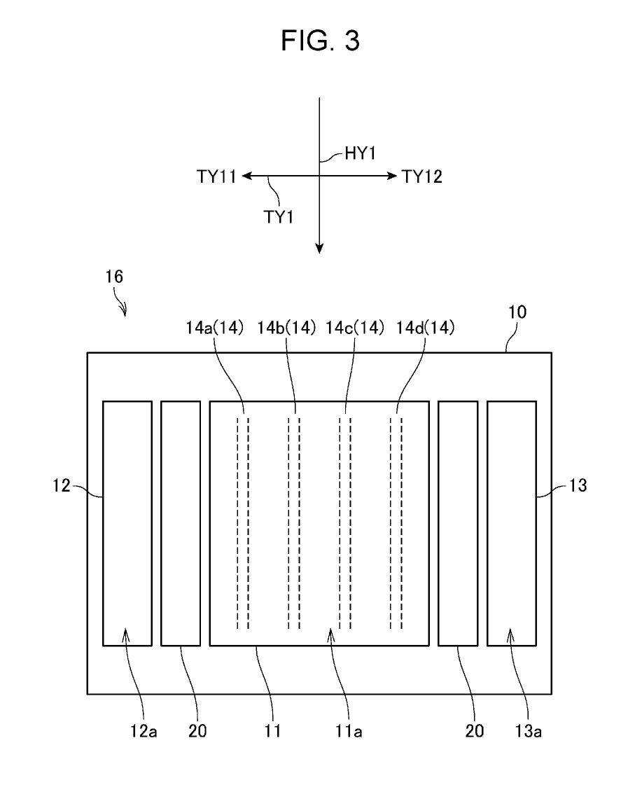

FIG. 2 is a perspective view illustrating a head unit 16 of the printing apparatus 1 according to the first embodiment. In addition, FIG. 3 is a schematic view from an ink discharge surface 11a side of FIG. 2.

As illustrated in FIG. 2, a serial type ink jet head 11 is mounted on the carriage 10.

A surface opposing the platen 2 of the ink jet head 11 is the ink discharge surface 11a. On the ink discharge surface 11a, an ink discharge nozzle row 14a to an ink discharge nozzle row 14d which are opened to the ink discharge surface 11a and configured with a plurality of nozzle holes for discharging a UV ink onto the printing medium 3, are formed. In the present embodiment, each of the ink discharge nozzle rows 14a to 14d is formed in two rows in parallel.

The UV ink is an ultraviolet curing ink that is cured by being irradiated with an ultraviolet ray (hereinafter, referred to as UV light). In the present embodiment, curing indicates at least one of temporary curing and main curing. The temporary curing and the main curing will be described later.

Further, in the present embodiment, the ink discharge nozzle row 14a discharges a cyan (C) UV ink onto the printing medium 3. In addition, the ink discharge nozzle row 14b discharges a magenta (M) UV ink onto the printing medium 3. Further, the ink discharge nozzle row 14c discharges a yellow (Y) UV ink onto the printing medium 3. In addition, the ink discharge nozzle row 14d discharges a black (K) UV ink onto the printing medium 3.

In addition, in the following description, in a case of describing each of the ink discharge nozzle row 14a to the ink discharge nozzle row 14d as one ink discharge nozzle row without distinction, the ink discharge nozzle rows will be referred to as an ink discharge nozzle row 14.

On the carriage 10, a UV light source 12 is mounted interposing a plasma actuator 20 which will be described later therebetween on a moving direction TY11 side of the carriage. In addition, on the carriage 10, a UV light source 13 is mounted interposing the plasma actuator 20 which will be described later therebetween on a moving direction TY12 side of the carriage.

The UV light source 12 and the UV light source 13 are configured with, for example, an LED, the UV ink discharged onto the printing medium 3 is irradiated with the UV light, and the UV ink is cured.

The UV light source 12 is disposed such that an irradiated surface 12a opposes the platen 2. The irradiated surface 12a is a surface irradiated with the UV light from the UV light source. In addition, the UV light source 13 is disposed such that an irradiated surface 13a opposes the platen 2. The irradiated surface 13a is a surface irradiated with the UV light from the UV light source.

Here, a gap (space) between the ink discharge surface 11a and the platen 2, or the gap (space) between the ink discharge surface 11a and the printing medium 3 is collectively referred to as a platen gap.

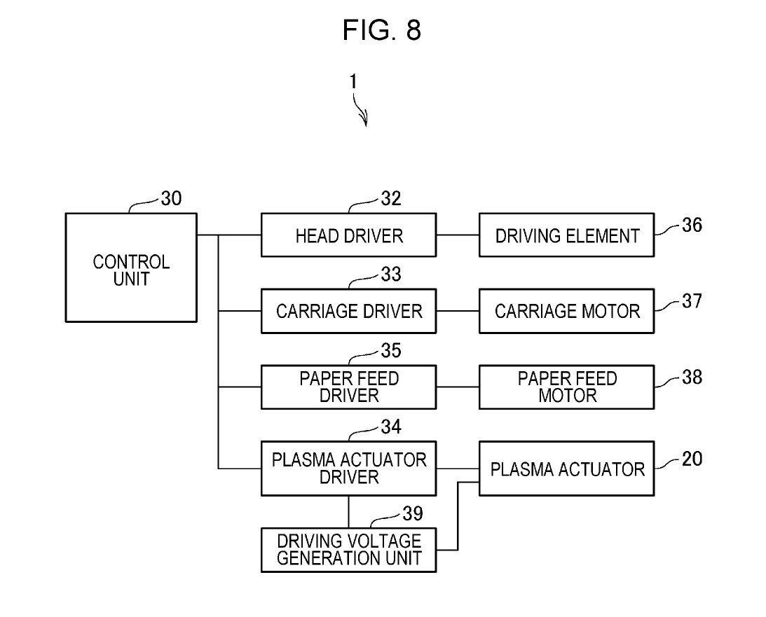

The ink jet head 11 includes a driving element 36 (FIG. 8), such as a piezoelectric element for discharging the UV ink from the ink discharge nozzle rows 14a to 14d. In addition, ink cartridges 15a to 15d for supplying the ink to the ink jet head 11 are mounted on the carriage 10. The ink cartridge 15a supplies the cyan UV ink to the ink discharge nozzle row 14a. In addition, the ink cartridge 15b supplies the magenta UV ink to the ink discharge nozzle row 14b. The ink cartridge 15c supplies the yellow UV ink to the ink discharge nozzle row 14c. In addition, the ink cartridge 15d supplies the black UV ink to the ink discharge nozzle row 14d.

In this manner, the head unit 16 is configured with the carriage 10, the ink jet head 11, the UV light source 12, the UV light source 13, and the ink cartridges 15a to 15d. In addition, in the present embodiment, a case where the ink jet head 11, the UV light source 12, and the UV light source 13 are separately configured is illustrated, but the ink jet head 11, the UV light source 12, and the UV light source 13 may be configured to be integrated with each other. In addition, each of the ink cartridges 15a to 15d may be installed at a place other than the head unit 16.

The plasma actuator 20 is disposed between the ink discharge surface 11a and the irradiated surface 12a and between the ink discharge surface 11a and the irradiated surface 13a. In other words, the two plasma actuators 20 are disposed to interpose the ink discharge surface 11a therebetween. In other words, the two plasma actuators 20 are disposed to interpose the ink discharge nozzle row 14 therebetween. Each of the plasma actuators 20 is formed to be longer than the length of the printing medium 3 in the transport direction HY1 with respect to the ink discharge nozzle row 14, the irradiated surface 12a of the UV light source 12, and the irradiated surface 13a of the UV light source 13. By doing so, the mist generated from the ink discharge nozzle row 14 becomes unlikely to adhere to the irradiated surface 12a of the UV light source 12 and the irradiated surface 13a of the UV light source 13, and it is possible to reduce occurrence of irradiation failure of the UV light source due to the mist of the UV ink. The support of each of the plasma actuators 20 may be any support, may be supported by being fitted to the ink jet head 11, or may be supported by the carriage 10.

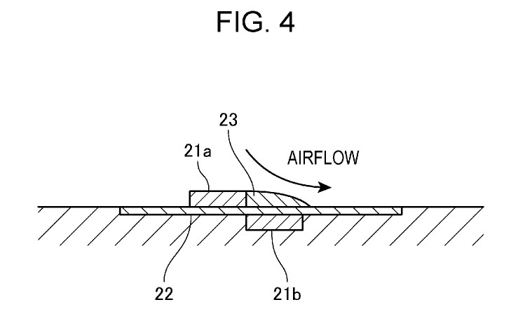

FIG. 4 is a sectional view illustrating a basic structure of the plasma actuator 20. As illustrated in FIG. 4, the plasma actuator 20 is configured with two thin film electrodes 21a and 21b and a dielectric layer 22 interposed between the electrodes 21a and 21b. By applying an AC voltage of several kV and a frequency of several kHz between the two electrodes 21a and 21b, a plasma discharge 23 is generated at a part interposed between the upper electrode 21a and the dielectric 22, and accordingly, an airflow that flows from the upper electrode 21a to the lower electrode 21b is generated. The plasma actuator 20 can simply control the generation, stop, or airflow velocity of the airflow by controlling the application of the AC voltage. This is a feature that is difficult to be realized with an airflow generating device, such as a fan. In addition, two thin film electrodes 21b may be prepared and disposed so as to interpose the electrode 21a. By doing so, when one side of the two electrodes 21b is selected, a direction in which the airflow is generated can be controlled in both forward and reverse directions.

Here, a printing operation of the printing apparatus 1 in the present embodiment will be described.

The printing apparatus 1 discharges the UV ink by the ink discharge nozzle rows 14a to 14d with respect to the printing medium 3, and when printing an image on the printing medium 3, the discharged UV ink is irradiated with the UV light from the UV light source 12 and the UV light source 13, is temporarily cured, and is mainly cured. The temporary curing means curing the surface of the UV ink to the extent that the UV ink discharged onto the printing medium 3 does not flow or blur from the printing medium 3. Therefore, it is necessary to irradiate the UV ink with the UV light immediately after the discharge of the UV ink. The main curing refers to completely curing the inside of the UV ink by irradiating the temporarily cured UV ink with the UV light having a larger amount of light than that of the temporary curing.

For example, while moving the carriage 10 in the direction TY11, the printing apparatus 1 discharges the UV ink from the ink discharge nozzle row 14 onto the printing medium 3 and at the same time irradiates the irradiated surface 13a of the UV light source 13 with the UV light, and the temporary curing is performed with respect to the UV ink discharged onto the printing medium 3 during the movement of the carriage 10 in the direction TY11. When performing the temporary curing, the printing apparatus 1 moves the carriage 10 in the direction TY12, irradiates the temporarily cured UV ink with the UV light from both the irradiated surface 12a of the UV light source 12 and the irradiated surface 13a of the UV light source 13, and performs the main curing. At this time, the UV ink is not discharged. In addition, the moving direction of the carriage 10 when discharging the UV ink may be the TY12 direction. In this case, the UV light source 12 is responsible for the UV light irradiation for the temporary curing.

A printing method of curing the UV ink by the UV light source 12 and the UV light source 13 makes it possible to use, for example, a plastic film or the like having low ink absorptivity as the printing medium 13.

However, in a case where the plasma actuator 20 is not provided, in the printing method, there is a case where the mist of the UV ink discharged from the ink discharge nozzle row 14 adheres to the irradiated surface 12a of the UV light source 12 and the irradiated surface 13a of the UV light source 13, and the mist is cured on the irradiated surface 12a and the irradiated surface 13a. When the mist of the UV ink is cured on the irradiated surface 12a and the irradiated surface 13a, the amount of UV light emitted from the UV light source 12 and the UV light source 13 decreases, and there is a possibility that the UV ink discharged onto the printing medium 3 is not be appropriately cured. In other words, there is a possibility that irradiation failure of the UV light source 12 and the UV light source 13 occurs. In particular, when the ink jet head 11 moves, there is a possibility that the airflow is generated in the platen gap in the direction opposite to the moving direction due to the movement of the ink jet head 11. In this case, for example, when the ink jet head 11 moves in the direction TY11, there is a high probability that the mist of the UV ink discharged from the ink discharge nozzle row 14 flows in the direction opposite to the direction TY11 (direction TY12), and adheres to the irradiated surface 13a of the UV light source 13.

Here, the plasma actuator 20 is disposed as illustrated in FIGS. 2 and 3. In other words, the plasma actuator 20 is disposed between the ink discharge nozzle row 14 and the irradiated surface 12a of the UV light source 12, and between the ink discharge nozzle row 14 and the irradiated surface 13a of the UV light source 13. The two thin film electrodes 21a and 21b of the plasma actuator 20 and the dielectric layer 22 interposed between the electrodes 21a and 21b are disposed in the gap between the ink jet head 11 and the plasma actuator 20 in FIG. 2 and in the gap between the UV light source 12 or the UV light source 13 and the plasma actuator 20. The two thin film electrodes 21a and 21b of the plasma actuator 20 and the dielectric layer 22 may be disposed in both gaps. By disposing the plasma actuator 20 in this manner, it is possible to generate the airflow by the plasma actuator 20 between the ink discharge nozzle row 14 and the irradiated surface 12a of the UV light source 12, and between the ink discharge nozzle row 14 and the irradiated surface 13a of the UV light source 13. Therefore, it is possible to suppress adhesion of the mist of the UV ink discharged from the ink discharge nozzle row 14 to the irradiated surface 12a of the UV light source 12, and to suppress adhesion of the mist of the UV ink discharged from the ink discharge nozzle row 14 to the irradiated surface 13a of the UV light source 13. Therefore, the printing apparatus 1 can reduce the occurrence of irradiation failure of the UV light source 12 and the UV light source 13 due to the mist of the UV ink.

In addition, in the present embodiment, the space between the ink discharge nozzle row 14 and the irradiated surface 12a of the UV light source 12 corresponds to the space between the ink discharge nozzle row 14 and the UV light source 12. Further, the space between the ink discharge nozzle row 14 and the irradiated surface 13a of the UV light source 13 corresponds to the space between the ink discharge nozzle row 14 and the UV light source 13.

In addition, as illustrated in FIGS. 2 and 3, the plasma actuator 20 is disposed side by side with the ink discharge nozzle row 14 in the moving direction of the carriage 10. Here, the moving direction of the carriage 10 corresponds to the direction TY1 orthogonal to the transport direction HY1. By disposing the plasma actuator 20 and generating the airflow by the plasma actuator 20 in this manner, it is possible to suppress the adhesion of the mist of the UV ink discharged from the ink discharge nozzle row 14 disposed in the direction TY1 to the irradiated surface 12a of the UV light source 12 and the irradiated surface 13a of the UV light source 13. Therefore, the printing apparatus 1 can reduce the occurrence of irradiation failure of the UV light source 12 and the UV light source 13 due to the mist of the UV ink.

In addition, the two plasma actuators 20 are disposed to interpose the ink discharge surface 11a therebetween. By disposing the two plasma actuators 20 to interpose the ink discharge surface 11a therebetween and generating the airflow by the plasma actuators 20 in this manner, it is possible to suppress the adhesion of the mist of the UV ink discharged from the ink discharge nozzle row 14 to the irradiated surface 12a of the UV light source 12 and the irradiated surface 13a of the UV light source 13 regardless of the moving direction of the ink jet head 11.

Further, as illustrated in FIG. 3, the plasma actuator 20 generates the airflow in a discharge direction IY1 (in a case of FIG. 3, from the nozzle surface 11a toward a front side) in which the ink discharge nozzle row 14 discharges the UV ink. Since the plasma actuator 20 generates the airflow in the discharge direction IY1 in this manner, an air curtain is formed between the ink discharge nozzle row 14 and the UV light source 12 and between the ink discharge nozzle row 14 and the UV light source 13. Therefore, the mist of the UV ink becomes unlikely to adhere to the irradiated surface 12a of the UV light source 12 and the irradiated surface 13a of the UV light source 13, and it is possible to reduce occurrence of irradiation failure of the UV light source 12 and the UV light source 13 due to the mist of the UV ink. In addition, since the plasma actuator 20 generates the airflow in the discharge direction IY1 of the UV ink, it is possible to suppress disturbance of a landing position of the UV ink. Further, it becomes possible to make the mist of the UV ink land on the printing medium 3.

In addition, in the present embodiment, generation of the airflow in the discharge direction IY1 corresponds to generation of the airflow in a direction away from the irradiated surface of the UV light source.

Next, a modification example of disposition of the plasma actuators 20 will be described.

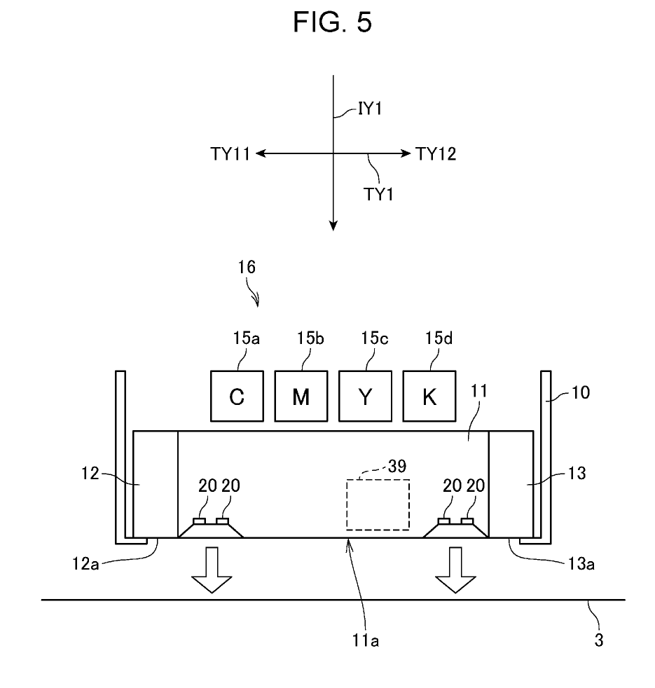

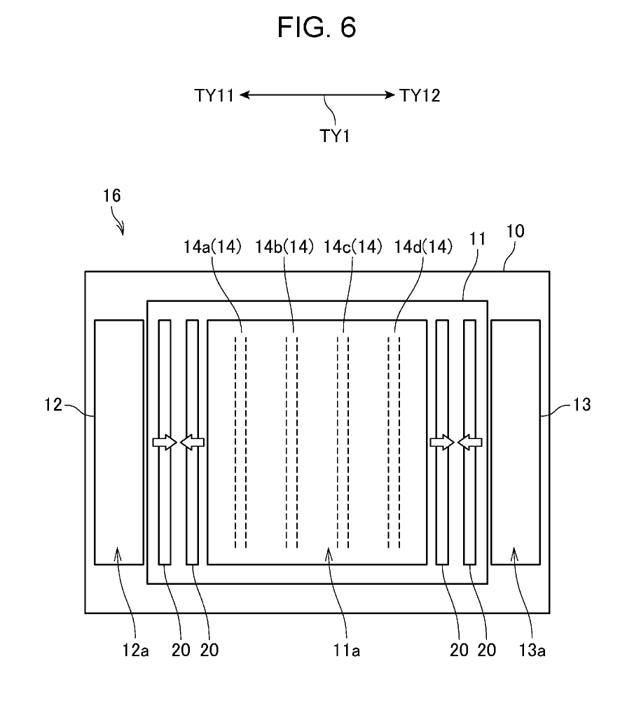

FIGS. 5 and 6 are views illustrating modification examples of the disposition of the plasma actuators 20. FIG. 5 is a schematic view of the head unit 16 of the printing apparatus 1. In addition, FIG. 6 is a schematic view when the head unit 16 is viewed from the ink discharge surface 11a of FIG. 5.

Configurations similar to those in FIGS. 2 and 3 will be given the same reference numerals, and the detailed description thereof will be omitted.

As can be apparent by comparing to FIGS. 2 and 3, in the modification example, there is no gap between the ink jet head 11 and the plasma actuator 20 and between the UV light source 12 or the UV light source 13 and the plasma actuator 20. Therefore, it is not possible to dispose the electrodes as illustrated in FIGS. 2 and 3. Here, in the present modification example, the plasma actuators 20 are disposed two by two between the ink discharge nozzle row 14 and the irradiated surface 12a of the UV light source 12 and between the ink discharge nozzle row 14 and the irradiated surface 13a of the UV light source 13 such that the airflows are generated in directions facing each other.

By disposing each of the plasma actuators 20 in this manner, since the airflows facing each other collide with each other between the two plasma actuators 20, as illustrated in FIG. 5, it is possible to generate the airflow in the discharge direction IY1 in which the UV ink is discharged. Therefore, even in a case where the plasma actuator 20 is disposed as illustrated in FIGS. 5 and 6, the same effects as those described above can be obtained.

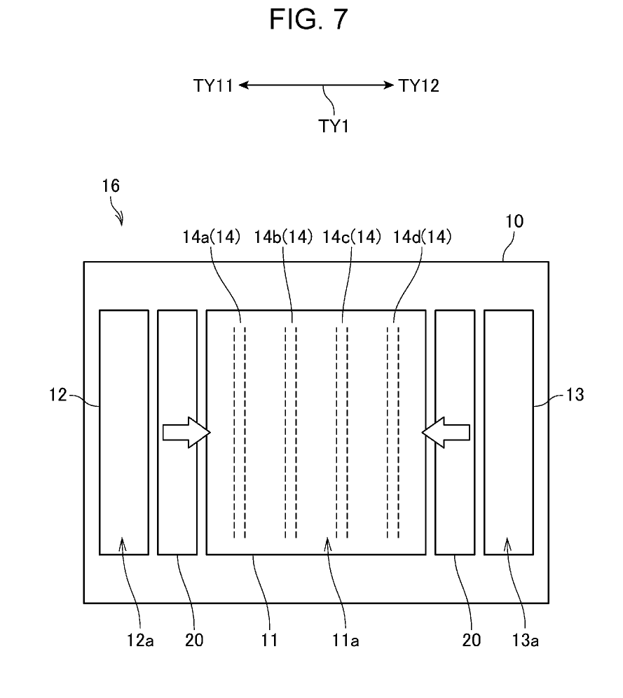

In addition, in the present embodiment, a case where the plasma actuator 20 generates the airflow in the discharge direction IY1 of the UV ink has been exemplified, but when it is possible to suppress the adhesion of the mist of the UV ink to the irradiated surface 12a of the UV light source 12 and the irradiated surface 13a of the UV light source 13, the direction in which the airflow is generated is not limited to the discharge direction IY1 of the UV ink. For example, in the direction illustrated in FIG. 7, the plasma actuator 20 may generate the airflow.

FIG. 7 is a view illustrating a modification example of the airflow generated by the plasma actuators 20. In addition, the same part as that in FIG. 3 will be given the same reference numerals, and the detailed description thereof will be omitted.

In other words, as illustrated in FIG. 7, the plasma actuator 20 between the ink discharge nozzle row 14 and the irradiated surface 12a of the UV light source 12 may generate the airflow in the direction TY12, and the plasma actuator 20 between the ink discharge nozzle row 14 and the irradiated surface 13a of the UV light source 13 may generate the airflow in the direction TY11.

The directions of the airflows also correspond to the direction away from the plasma actuator 20.

As illustrated in FIG. 7, by generating the airflow by the plasma actuator 20, it is possible to suppress the adhesion of the mist of the UV ink discharged from the ink discharge nozzle row 14 to the irradiated surface 12a of the UV light source 12 and the irradiated surface 13a of the UV light source 13. Therefore, the printing apparatus 1 can reduce the occurrence of irradiation failure of the UV light source 12 and the UV light source 13 due to the mist of the UV ink.

Next, a functional configuration of the present embodiment will be described.

FIG. 8 is a block diagram illustrating the functional configuration of the printing apparatus 1 according to the present embodiment.

As illustrated in FIG. 8, the printing apparatus 1 includes a control unit 30 for controlling each part, and various driver circuits for driving various motors and the like in accordance with the control of the control unit 30 or outputting a detection state of a detection circuit to the control unit 30. The various driver circuits include a head driver 32, a carriage driver 33, a plasma actuator driver 34, and a paper feed driver 35.

The control unit 30 centrally controls each part of the printing apparatus 1. The control unit 30 includes a CPU, an executable basic control program, a ROM that stores data or the like related to the basic control program in a nonvolatile manner, a RAM that temporarily stores programs executed by the CPU, predetermined data, and the like, other peripheral circuits, and the like.

The head driver 32 is connected to a driving element 36, such as a piezoelectric element for discharging the ink, respectively. The driving element 36 is driven under the control of the control unit 30 and discharges a necessary amount of ink from the nozzle hole.

The carriage driver 33 is connected to the carriage motor 37, outputs a driving signal to the carriage motor 37, and operates the carriage motor 37 within a range instructed by the control unit 30.

The plasma actuator driver 34 is connected to the plasma actuator 20, outputs the driving signal to the plasma actuator 20, and drives the plasma actuator 20 by the control unit 30.

The paper feed driver 35 is connected to a paper feed motor 38, outputs the driving signal to the paper feed motor 38, and operates the paper feed motor 38 only by an amount instructed by the control unit 30. In accordance with the operation of the paper feed motor 38, the printing medium 3 is transported only by a predetermined amount in the transport direction HY1.

In order to drive the plasma actuator 20, a high voltage is required. The printing apparatus 1 includes a driving voltage generation unit 39 for generating a driving voltage for driving the plasma actuator 20. The driving voltage generation unit 39 is connected to the plasma actuator 20 and the plasma actuator driver 34. The driving voltage generation unit 39 is supported by the carriage 10, for example, and is mounted on the head unit 16.

In addition, the driving voltage generation unit 39 may configure a UV light source unit together with at least the UV light source 12 and the UV light source 13, and may be mounted on the UV light source unit. In this case, the UV light source unit is mounted on the carriage 10 and configures the head unit.

A flexible cable for transmitting a head driving signal is disposed on the moving carriage 10. Additionally laying a high voltage wiring for driving the plasma actuator 20 in the flexible cable is not preferable because problems, such as insulation distance, short-circuiting measures, noise countermeasure, and the like, occur.

Therefore, in the present embodiment, a low voltage power source supply line is disposed in the flexible cable, and the driving voltage generation unit 39 is mounted on the head unit 16. The driving voltage generation unit 39 takes the low voltage power source as an input voltage and boosts the voltage to a high voltage in the head unit 16.

In addition, in a case where a piezoelectric element is used as the driving element 36, since the power source supply line for driving the piezoelectric element is laid in the flexible cable, the power source for driving the piezoelectric element may be used as an input voltage of the driving voltage generation unit 39. In addition, even in a case where a thermal type driving element is used as the driving element 36, similarly, a thermal head driving power source can be used as the input voltage of the driving voltage generation unit 39. It is needless to say that an independent low voltage power source line may be laid in the flexible cable. In addition, in a case where the power source supply line for the UV light source is laid in the flexible cable, the power source for the UV light source may be used as the input voltage of the driving voltage generation unit 39.

In addition, when problems, such as insulation distance, short-circuiting measures, noise countermeasures, and the like, do not occur, the high voltage wiring for driving the plasma actuator 20 may be laid in the flexible cable, and for the high voltage wiring, a cable different from the flexible cable for transmitting the head driving signal may be laid.

In this manner, since the driving voltage generation unit 39 is mounted on the head unit 16, it is possible to generate the driving voltage to the plasma actuator 20 driven with a high voltage by the driving voltage generation unit 39. Therefore, it is unnecessary to lay the high voltage wiring in the flexible cable provided in the carriage 10, and problems, such as insulation, short-circuiting measures, noise countermeasures, and the like, do not occur.

As described above, the printing apparatus 1 includes: the ink discharge nozzle row 14 for discharging the UV ink; the UV light source 12 and the UV light source 13 for emitting the UV light for curing the UV ink; and the plasma actuator 20 that generates the airflow in the direction away from the irradiated surface 12a of the UV light source 12 and the irradiated surface 13a of the UV light source 13.

Accordingly, since the plasma actuator 20 generates the airflow in the direction away from the irradiated surface 12a of the UV light source 12 and the irradiated surface 13a of the UV light source 13, the mist of the UV ink becomes unlikely to adhere to the irradiated surface 12a of the UV light source 12 and the irradiated surface 13a of the UV light source 13, and it is possible to reduce occurrence of the irradiation failure of the UV light source 12 and the UV light source 13 due to the mist of the UV ink. Further, by providing the plasma actuator 20, there is no need to provide a large-scale apparatus for wiping the mist of the UV ink that has adhered to the irradiated surface 12a and the irradiated surface 13a, and equipment cost can be reduced.

In addition, the plasma actuator 20 is disposed between the ink discharge nozzle row 14 and the irradiated surface 12a of the UV light source 12. In addition, the plasma actuator 20 is disposed between the ink discharge nozzle row 14 and the irradiated surface 13a of the UV light source 13.

Accordingly, since the plasma actuator 20 is disposed between the ink discharge nozzle row 14 and the UV light source 12 and between the ink discharge nozzle row 14 and the UV light source 13, the airflow can be generated therebetween, and the mist of the UV ink becomes unlikely to adhere to the irradiated surface 12a of the UV light source 12 and the irradiated surface 13a of the UV light source 13. Therefore, the printing apparatus 1 can reduce the occurrence of irradiation failure of the UV light source 12 and the UV light source 13 due to the mist of the UV ink.

In addition, the printing apparatus 1 includes the ink jet head 11 that is mounted on the carriage 10 that reciprocates in the direction intersecting with the transport direction HY1 of the printing medium 3 and has the ink discharge nozzle row 14b.

Accordingly, in the serial type ink jet head 11 mounted on the carriage 10, the mist of the UV ink becomes unlikely to adhere to the irradiated surface 12a of the UV light source 12 and the irradiated surface 13a of the UV light source 13. Therefore, the printing apparatus 1 can reduce the occurrence of irradiation failure of the UV light source 12 and the UV light source 13 due to the mist of the UV ink.

In addition, the plasma actuator 20 is disposed side by side with the ink discharge nozzle row 14 in the moving direction of the carriage 10.

Accordingly, since the plasma actuator 20 is disposed side by side with the ink discharge nozzle row 14 in the moving direction of the carriage 10, the mist of the UV ink discharged from the ink discharge nozzle row 14 becomes unlikely to adhere to the irradiated surface 12a of the UV light source 12 and the irradiated surface 13a of the UV light source 13. Therefore, the printing apparatus 1 can reduce the occurrence of irradiation failure of the UV light source 12 and the UV light source 13 due to the mist of the UV ink.

In addition, the printing apparatus 1 includes a plurality (two in the present embodiment) of the plasma actuators 20 disposed to interpose the ink discharge nozzle row 14 therebetween.

Accordingly, since the plurality of plasma actuators 20 disposed to interpose the ink discharge nozzle row 14 therebetween are provided, the mist of the UV ink becomes unlikely to adhere to the irradiated surface 12a of the UV light source 12 and the irradiated surface 13a of the UV light source 13 regardless of the moving direction of the carriage 10. Therefore, the printing apparatus 1 can reduce the occurrence of irradiation failure of the UV light source 12 and the UV light source 13 due to the mist of the UV ink.

In addition, the plasma actuator 20 generates the airflow in the discharge direction IY1 in which the ink discharge nozzle row 14 discharges the UV ink.

Accordingly, since the plasma actuator 20 generates the airflow in the discharge direction IY1 in which the ink discharge nozzle row 14 discharges the UV ink, the air curtain is formed by the airflow between the ink discharge nozzle row 14 and the UV light source 12 and between the ink discharge nozzle row 14 and the UV light source 13. Therefore, in the printing apparatus 1, the mist of the UV ink becomes unlikely to adhere to the irradiated surface 12a of the UV light source 12 and the irradiated surface 13a of the UV light source 13, and it is possible to reduce occurrence of irradiation failure of the UV light source 12 and the UV light source 13 due to the mist of the UV ink.

In addition, in the printing apparatus 1, the driving voltage generation unit 39 is mounted on the head unit 16.

Accordingly, it is possible to generate the driving voltage to the plasma actuator 20 driven with a high voltage by the driving voltage generation unit 39. Therefore, it is unnecessary to lay the high voltage wiring in the flexible cable connected to the carriage 10, and problems, such as insulation, short-circuiting measures, noise countermeasures, and the like, do not occur.

### Second Embodiment

Next, a second embodiment will be described.

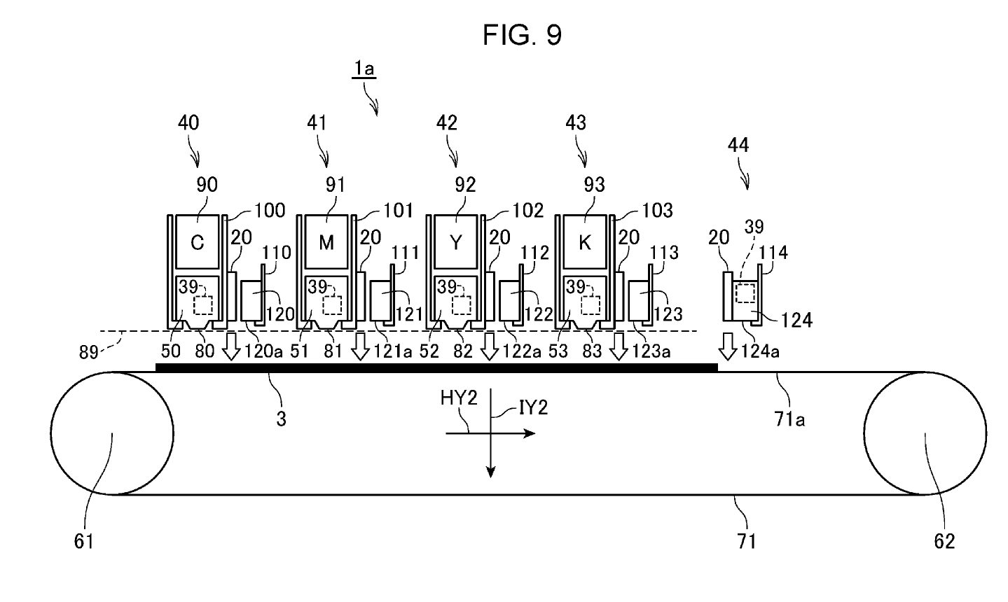

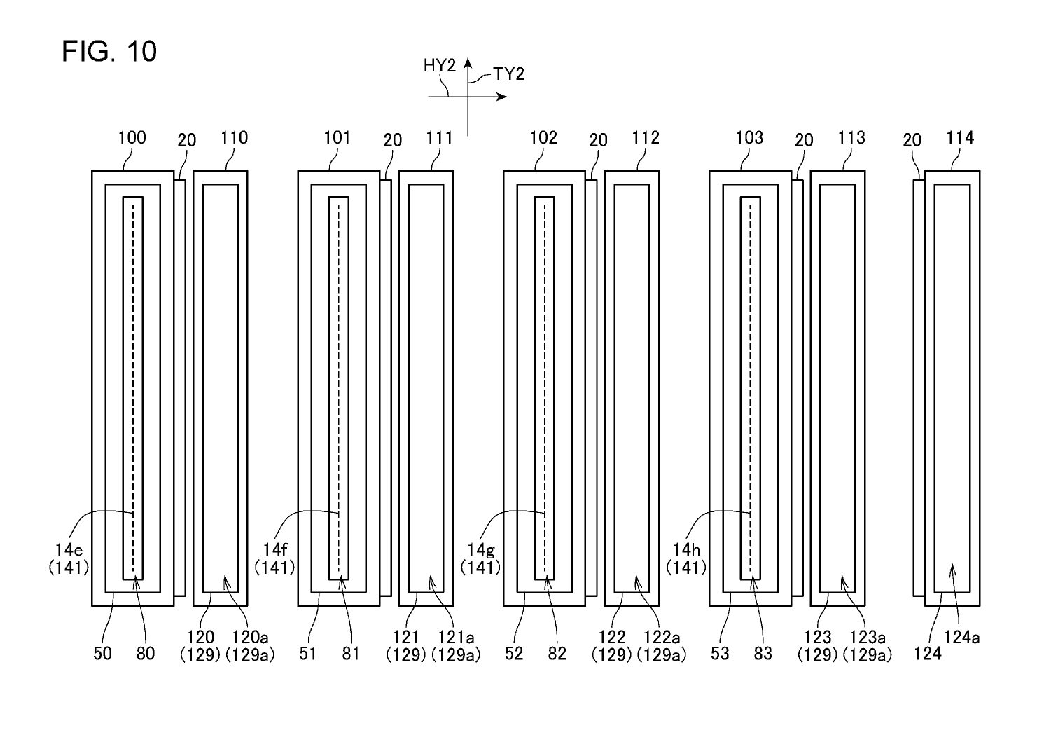

FIG. 9 is a view illustrating an outline of a printing apparatus 1a according to the second embodiment. In addition, FIG. 10 is a schematic view from an ink discharge surface 89 side of FIG. 9.

As illustrated in FIG. 9, the printing apparatus 1a according to the second embodiment includes, in order from the upstream side in a transport direction HY2 of the printing medium, a head unit 40 having an ink jet head 50 for discharging the cyan UV ink, a head unit 41 having an ink jet head 51 for discharging the magenta UV ink, a head unit 42 having an ink jet head 52 for discharging the yellow UV ink, a head unit 43 having an ink jet head 53 for discharging the black UV ink, and a UV light source unit 44.

The printing medium 3 is held by a transport belt 71 hung between a roller 61 and a roller 62 and transported in the transport direction HY2. In the following description, the transport belt that moves in the transport direction HY2 in the transport belt 71 is referred to as a transport belt 71a.

As illustrated in FIGS. 9 and 10, the ink jet head 50 is a line type head and is supported by a supporting member 100. A surface opposing the transport belt 71a of the ink jet head 50 is an ink discharge surface 80. On the ink discharge surface 80, an ink discharge nozzle row 14e which is opened to the ink discharge surface 80 and configured with a plurality of nozzle holes for discharging the cyan ink onto the printing medium 3, is formed. The ink discharge nozzle row 14e is formed so as to extend in a direction TY2 orthogonal to the transport direction HY2 of the printing medium 3. The ink jet head 50 includes the driving element 36, such as a piezoelectric element for discharging the UV ink from the ink discharge nozzle row 14e. In addition, an ink cartridge 90 for supplying the cyan ink to the ink jet head 50 is mounted on a supporting member 101.

The head unit 40 is configured with the supporting member 101, the ink jet head 50, and the ink cartridge 90.

On the downstream side in the transport direction HY2 of the head unit 40, a UV light source 120 supported by a supporting member 110 is disposed. The UV light source 120 is disposed such that an irradiated surface 120a irradiated with the UV light opposes the transport belt 71a. The irradiated surface 120a extends in the direction TY2 orthogonal to the transport direction HY2 of the printing medium 3.

The ink jet head 51 is a line type head and is supported by the supporting member 101. A surface opposing the transport belt 71a of the ink jet head 51 is an ink discharge surface 81. On the ink discharge surface 81, an ink discharge nozzle row 14f which is opened to the ink discharge surface 81 and configured with a plurality of nozzle holes for discharging the magenta ink onto the printing medium 3, is formed. The ink discharge nozzle row 14f is formed so as to extend in the direction TY2 orthogonal to the transport direction HY2 of the printing medium 3. The ink jet head 51 includes the driving element 36, such as a piezoelectric element for discharging the UV ink from the ink discharge nozzle row 14f. In addition, an ink cartridge 91 for supplying the magenta ink to the ink jet head 51 is mounted on the supporting member 101.

The head unit 41 is configured with the supporting member 101, the ink jet head 51, and the ink cartridge 91.

On the downstream side in the transport direction HY2 of the head unit 41, a UV light source 121 supported by a supporting member 111 is disposed. The UV light source 121 is disposed such that an irradiated surface 121a irradiated with the UV light opposes the transport belt 71a. The irradiated surface 121a extends in the direction TY2 orthogonal to the transport direction HY2 of the printing medium 3.

The ink jet head 52 is a line type head and is supported by a supporting member 102. A surface opposing the transport belt 71a of the ink jet head 52 is an ink discharge surface 82. On the ink discharge surface 82, an ink discharge nozzle row 14g which is opened to the ink discharge surface 82 and configured with a plurality of nozzle holes for discharging the yellow ink onto the printing medium 3, is formed. The ink discharge nozzle row 14g is formed so as to extend in the direction TY2 orthogonal to the transport direction HY2 of the printing medium 3. The ink jet head 52 includes the driving element 36, such as a piezoelectric element for discharging the UV ink from the ink discharge nozzle row 14g. In addition, an ink cartridge 92 for supplying the yellow ink to the ink jet head 52 is mounted on the supporting member 102.

The head unit 42 is configured with the supporting member 102, the ink jet head 52, and the ink cartridge 92.

On the downstream side in the transport direction HY2 of the head unit 42, a UV light source 122 supported by a supporting member 112 is disposed. The UV light source 122 is disposed such that an irradiated surface 122a irradiated with the UV light opposes the transport belt 71a. The irradiated surface 122a extends in the direction TY2 orthogonal to the transport direction HY2 of the printing medium 3.

The ink jet head 53 is a line type head and is supported by a supporting member 103. A surface opposing the transport belt 71a of the ink jet head 53 is an ink discharge surface 83. On the ink discharge surface 83, an ink discharge nozzle row 14h which is opened to the ink discharge surface 83 and configured with a plurality of nozzle holes for discharging the black ink onto the printing medium 3, is formed. The ink discharge nozzle row 14h is formed so as to extend in the direction TY2 orthogonal to the transport direction HY2 of the printing medium 3. The ink jet head 53 includes the driving element 36, such as a piezoelectric element for discharging the UV ink from the ink discharge nozzle row 14h. In addition, an ink cartridge 93 for supplying the black ink to the ink jet head 53 is mounted on the supporting member 103.

The head unit 43 is configured with the supporting member 103, the ink jet head 53, and the ink cartridge 93.

On the downstream side in the transport direction HY2 of the head unit 43, a UV light source 123 supported by a supporting member 113 is disposed. The UV light source 123 is disposed such that an irradiated surface 123a irradiated with the UV light opposes the transport belt 71a. The irradiated surface 123a extends in the direction TY2 orthogonal to the transport direction HY2 of the printing medium 3.

On the downstream side in the transport direction HY2 of the UV light source 123, a UV light source 124 supported by a supporting member 114 is disposed. The UV light source 124 is disposed such that an irradiated surface 124a irradiated with the UV light opposes the transport belt 71a. The irradiated surface 124a extends in the direction TY2 orthogonal to the transport direction HY2 of the printing medium 3.

Here, a gap (space) between the ink discharge surface 89 and the transport belt 71a, or the gap (space) between the ink discharge surface 89 and the printing medium 3 also corresponds to a platen gap. In addition, the ink discharge surface 89 is a surface including the ink discharge surfaces 80 to 83.

In the following description, in a case of describing the ink discharge nozzle row 14e to the ink discharge nozzle row 14h as one ink discharge nozzle row without distinction, the ink discharge nozzle rows will be referred to as an ink discharge nozzle row 141.

The plasma actuator 20 is disposed between the ink discharge nozzle row 14e and the irradiated surface 120a of the UV light source 120. The plasma actuator 20 is formed longer than at least one of the length of the ink discharge nozzle row 14e and the length of the irradiated surface 120a of the UV light source 120 in the direction TY2. By doing so, the mist of the UV ink generated from the ink discharge nozzle row 14e becomes unlikely to adhere to the irradiated surface 120a, and it is possible to reduce occurrence of irradiation failure of the UV light source 120 due to the mist of the UV ink. In addition, as illustrated in FIG. 9, the plasma actuator 20 is disposed to generate the airflow in a discharge direction IY2 in which the ink discharge nozzle row 141 discharges the UV ink. In other words, the two thin film electrodes 21a and 21b of the plasma actuator 20 and the dielectric layer 22 interposed between the electrodes 21a and 21b are disposed in the gap between the UV light source 120 and the plasma actuator 20 in FIG. 9. In addition, the two thin film electrodes 21a and 21b of the plasma actuator 20 and the dielectric layer 22 interposed between the electrodes 21a and 21b may be disposed in the gap between the ink jet head 50 and the plasma actuator 20, or may be disposed in the both gaps. In the present embodiment, the plasma actuator 20 is supported by the supporting member 100. In addition, the support of the plasma actuator 20 may be supported, for example, by being fitted to the ink jet head 50, and may be any support as long as the support is disposed between the ink discharge nozzle row 14e and the UV light source 120.

In addition, the plasma actuator 20 is disposed between the ink discharge nozzle row 14f and the irradiated surface 121a of the UV light source 121. The plasma actuator 20 is formed longer than at least one of the length of the ink discharge nozzle row 14f and the length of the irradiated surface 121a of the UV light source 121 in the direction TY2. By doing so, the mist of the UV ink generated from the ink discharge nozzle row 14f becomes unlikely to adhere to the irradiated surface 121a, and it is possible to reduce occurrence of irradiation failure of the UV light source 120 due to the mist of the UV ink. In addition, as illustrated in FIG. 9, the plasma actuator 20 is disposed to generate the airflow in the discharge direction IY2 in which the ink discharge nozzle row 141 discharges the UV ink. In other words, the two thin film electrodes 21a and 21b of the plasma actuator 20 and the dielectric layer 22 interposed between the electrodes 21a and 21b are disposed in the gap between the UV light source 121 and the plasma actuator 20 in FIG. 9. In addition, the two thin film electrodes 21a and 21b of the plasma actuator 20 and the dielectric layer 22 interposed between the electrodes 21a and 21b may be disposed in the gap between the ink jet head 51 and the plasma actuator 20, or may be disposed in the both gaps. In the present embodiment, the plasma actuator 20 is supported by the supporting member 101. In addition, the support of the plasma actuator 20 may be supported, for example, by being fitted to the ink jet head 51, and may be any support as long as the support is disposed between the ink discharge nozzle row 14f and the UV light source 121.

In addition, the plasma actuator 20 is disposed between the ink discharge nozzle row 14g and the irradiated surface 122a of the UV light source 122. The plasma actuator 20 is formed longer than at least one of the length of the ink discharge nozzle row 14g and the length of the irradiated surface 122a of the UV light source 122 in the direction TY2. By doing so, the mist of the UV ink generated from the ink discharge nozzle row 14g becomes unlikely to adhere to the irradiated surface 122a, and it is possible to reduce occurrence of irradiation failure of the UV light source 120 due to the mist of the UV ink. In addition, as illustrated in FIG. 9, the plasma actuator 20 is disposed to generate the airflow in the discharge direction IY2 in which the ink discharge nozzle row 141 discharges the UV ink. In other words, the two thin film electrodes 21a and 21b of the plasma actuator 20 and the dielectric layer 22 interposed between the electrodes 21a and 21b are disposed in the gap between the UV light source 122 and the plasma actuator 20 in FIG. 9. In addition, the two thin film electrodes 21a and 21b of the plasma actuator 20 and the dielectric layer 22 interposed between the electrodes 21a and 21b may be disposed in the gap between the ink jet head 52 and the plasma actuator 20, or may be disposed in the both gaps. In the present embodiment, the plasma actuator 20 is supported by the supporting member 102. In addition, the support of the plasma actuator 20 may be supported, for example, by being fitted to the ink jet head 52, and may be any support as long as the support is disposed between the ink discharge nozzle row 14g and the UV light source 122.

In addition, the plasma actuator 20 is disposed between the ink discharge nozzle row 14h and the irradiated surface 123a of the UV light source 123. The plasma actuator 20 is formed longer than at least one of the length of the ink discharge nozzle row 14h and the length of the irradiated surface 123a of the UV light source 123 in the direction TY2. By doing so, the mist of the UV ink generated from the ink discharge nozzle row 14h becomes unlikely to adhere to the irradiated surface 123a, and it is possible to reduce occurrence of irradiation failure of the UV light source 120 due to the mist of the UV ink. In addition, as illustrated in FIG. 9, the plasma actuator 20 is disposed to generate the airflow in the discharge direction IY2 in which the ink discharge nozzle row 141 discharges the UV ink. In other words, the two thin film electrodes 21a and 21b of the plasma actuator 20 and the dielectric layer 22 interposed between the electrodes 21a and 21b are disposed in the gap between the UV light source 123 and the plasma actuator 20 in FIG. 9. In addition, the two thin film electrodes 21a and 21b of the plasma actuator 20 and the dielectric layer 22 interposed between the electrodes 21a and 21b may be disposed in the gap between the ink jet head 53 and the plasma actuator 20, or may be disposed in the both gaps. In the present embodiment, the plasma actuator 20 is supported by the supporting member 103. In addition, the support of the plasma actuator 20 may be supported, for example, by being fitted to the ink jet head 53, and may be any support as long as the support is disposed between the ink discharge nozzle row 14h and the UV light source 121.

In addition, the plasma actuator 20 is disposed between the UV light source 123 and the UV light source 124. The plasma actuator 20 is formed longer than the length of the irradiated surface 124a of the UV light source 124 in the direction TY2. In addition, as illustrated in FIG. 9, the plasma actuator 20 is disposed to generate the airflow in the discharge direction IY2 in which the ink discharge nozzle row 141 discharges the UV ink. In the present embodiment, the plasma actuator 20 is supported by the UV light source 124. In addition, the support of the plasma actuator 20 may be supported, for example, by the supporting member 114, and may be any support as long as the support is disposed between the UV light source 123 and the UV light source 124.

In the following description, in a case of describing the UV light source 120 to the UV light source 123 as one UV light source without distinction, the UV light sources will be referred to as a UV light source 129.

In addition, in the following description, in a case of describing the irradiated surface 120a to the irradiated surface 123a as one irradiated surface without distinction, the irradiated surfaces will be referred to as an irradiated surface 129a.

Here, a printing operation of the printing apparatus 1a in the present embodiment will be described.

The printing apparatus 1a discharges the UV ink by the ink discharge nozzle rows 14e to 14h while transporting the printing medium 3 in the transport direction HY2 while holding the printing medium 3 with the transport belt 71a, performs the temporary curing and the main curing with respect to the discharged UV ink, and accordingly, prints the image on the printing medium 3. More specifically, the printing apparatus 1a performs the temporary curing by the UV light source 120 when discharging the UV ink by the ink discharge nozzle row 14e, performs the temporary curing by the UV light source 121 when discharging the UV ink by the ink discharge nozzle row 14f, performs the temporary curing by the UV light source 122 when discharging the UV ink by the ink discharge nozzle row 14g, performs the temporary curing by the UV light source 123 when discharging the UV ink by the ink discharge nozzle row 14h, and performs the main curing by the UV light source 124 after performing these temporary curing.

In the printing method, there is a case where the mist of the UV ink discharged from the ink discharge nozzle row 141 adheres to the irradiated surface 129a of the UV light source 129, and the adhered mist is cured on the irradiated surface 129a.

As described above, when the mist of the UV ink is cured on the irradiated surface 129a, the amount of UV light emitted from the UV light source 129 decreases, and there is a possibility that the UV ink discharged onto the printing medium 3 is not be appropriately cured. In particular, when the printing medium 3 is transported in the transport direction HY2, there is a case where the airflow that flows in the transport direction HY2 is generated in the platen gap due to the transport of the printing medium 3, and there is a high probability that the mist of the UV ink flows to the downstream side in the transport direction HY2 and adheres to the irradiated surface 129a of the UV light source 129 disposed further on the downstream side than the ink discharge nozzle row 141.

Here, the plasma actuator 20 is disposed as illustrated in FIGS. 9 and 10. In other words, the plasma actuator 20 is disposed between the ink discharge nozzle row 14e and the irradiated surface 120a of the UV light source 120. In addition, the plasma actuator 20 is disposed between the ink discharge nozzle row 14f and the irradiated surface 121a of the UV light source 121. In addition, the plasma actuator 20 is disposed between the ink discharge nozzle row 14g and the irradiated surface 122a of the UV light source 122. In addition, the plasma actuator 20 is disposed between the ink discharge nozzle row 14h and the irradiated surface 123a of the UV light source 123.

Further, the space between the ink discharge nozzle row 141 and the irradiated surface 129a of the UV light source 129 corresponds to the space between the ink discharge nozzle row 141 and the UV light source 129.

Since the plasma actuator 20 is disposed in this manner, the printing apparatus 1a can generate the airflow between the ink discharge nozzle row 141 and the UV light source 129. Therefore, it is possible to suppress the adhesion of the mist of the UV ink discharged from the ink discharge nozzle row 141 to the irradiated surface 129a of the UV light source 129, and it is possible to reduce occurrence of irradiation failure of the UV light source 129 due to the mist of the UV ink.

In addition, as illustrated in FIGS. 9 and 10, the plasma actuator 20 is disposed side by side with the ink discharge nozzle row 141 in the transport direction HY2 of the printing medium 3. Since the plasma actuator 20 is disposed in this manner, it is possible to suppress the adhesion of the mist of the UV ink discharged from the ink discharge nozzle row 141 disposed in the transport direction HY2 of the printing medium 3 to the irradiated surface 129a of the UV light source 129, and it is possible to reduce occurrence of the irradiation failure of the UV light source 129 due to the mist of the UV ink.

In addition, as illustrated in FIG. 9, the plasma actuator 20 is disposed to generate the airflow in the discharge direction IY2 in which the ink discharge nozzle row 141 discharges the UV ink. Since the plasma actuator 20 is disposed in this manner, the air curtain is formed between the ink discharge nozzle row 141 and the UV light source 129. Therefore, it is possible to suppress the flow of the mist of the UV ink to the downstream side in the transport direction HY2. Therefore, the mist of the UV ink becomes unlikely to adhere to the irradiated surface 129a of the UV light source 129, and it is possible to reduce occurrence of irradiation failure of the UV light source 129 due to the mist of the UV ink. In addition, since the plasma actuator 20 generates the airflow in the discharge direction IY2 of the UV ink, it is possible to suppress disturbance of the landing position of the UV ink due to the airflow caused by the transport of the printing medium 3.

In addition, generation of the airflow in the discharge direction IY2 in which the UV ink is discharged corresponds to generation of the airflow in the direction away from the irradiated surface of the UV light source.

In the above-described configuration of the printing apparatus 1a, the configuration in a case of discharging the UV ink of each color including cyan, magenta, yellow, and black onto the printing medium 3 has been exemplified. However, depending on the printing apparatus 1a, in order to print a background image as a base image of an image formed by the UV ink of each color including cyan, magenta, yellow, and black, there is a case where background image printing UV ink which is the UV ink for printing the background image is discharged. In this case, the images formed by the UV ink of each color including cyan, magenta, yellow, and black correspond to a main image to be printed to be superimposed and printed on the background image, and the UV ink of each color including cyan, magenta, yellow, and black corresponds to main image printing UV ink which is the UV ink for printing the main image.

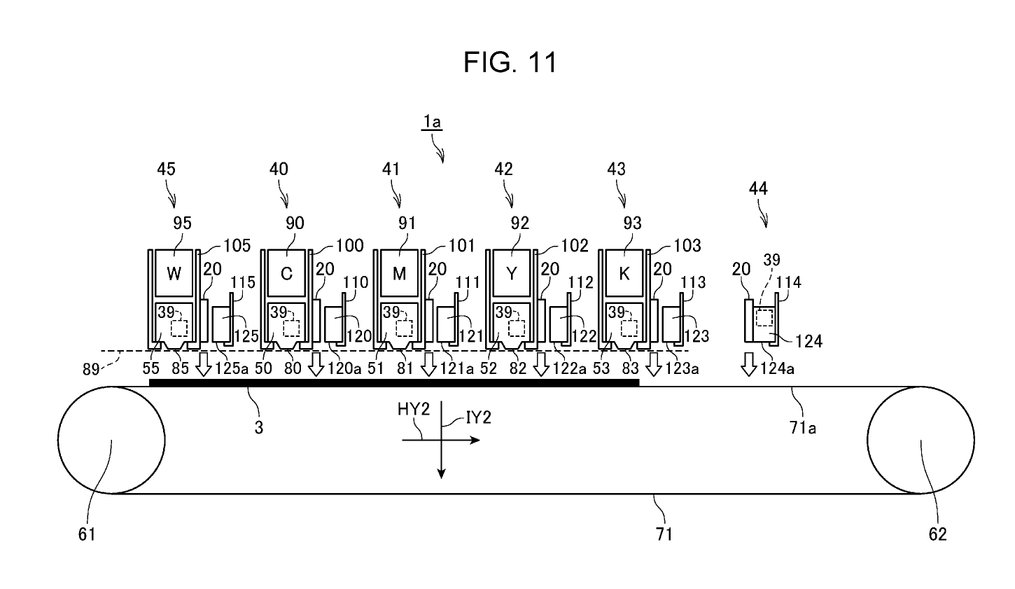

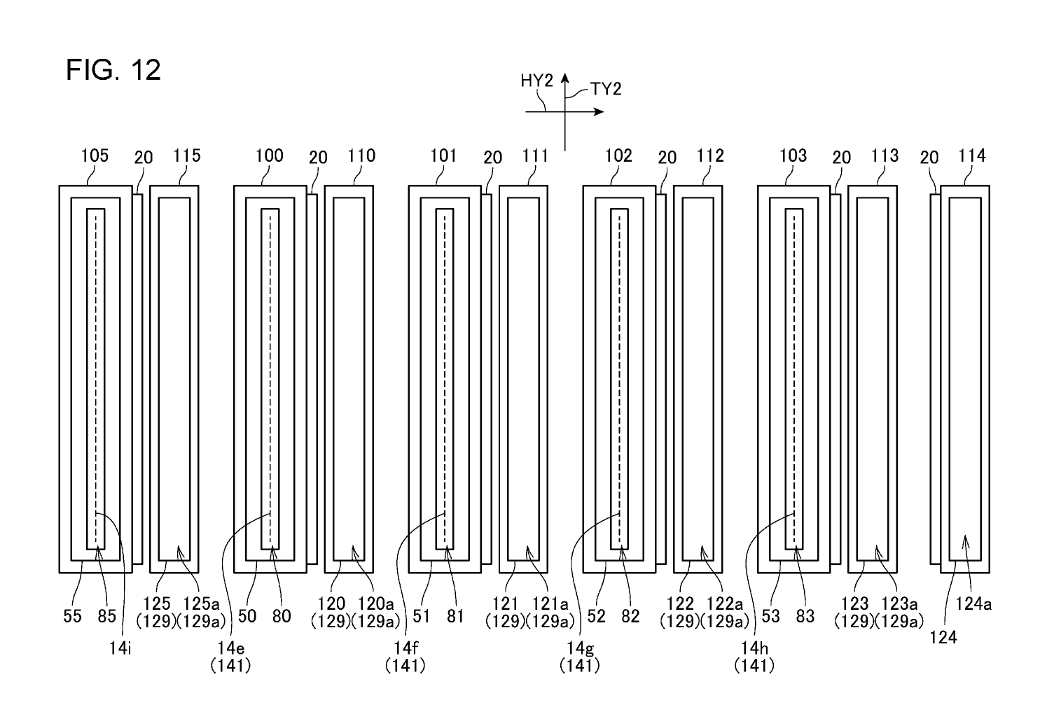

FIG. 11 is a view illustrating an outline of the printing apparatus 1a for discharging the background image printing UV ink. In addition, FIG. 12 is a schematic view from the ink discharge surface 89 side of FIG. 11. Further, the same parts as those in FIGS. 9 and 10 will be given the same reference numerals, and the description thereof will be omitted.

As can be apparent by comparing to FIG. 9, in the printing apparatus 1a for discharging the background image printing UV ink, a head unit 45 having an ink jet head 55 for discharging the background image printing UV ink is disposed further on the upstream side in the transport direction HY2 of the printing medium 3 than the head unit 40.

In the present embodiment, white (W) ink is exemplified as the background image printing ink.

As illustrated in FIGS. 11 and 12, the ink jet head 55 is a line type head and is supported by a supporting member 105. A surface opposing the transport belt 71a of the ink jet head 55 is an ink discharge surface 85. On the ink discharge surface 85, an ink discharge nozzle row 14i which is opened to the ink discharge surface 85 and configured with a plurality of nozzle holes for discharging the UV ink onto the printing medium 3, is formed. The ink discharge nozzle row 14i is formed so as to extend in the direction TY2 (intersecting direction) orthogonal to the transport direction HY2 of the printing medium 3.

The ink jet head 55 includes the driving element, such as a piezoelectric element for discharging the UV ink from the ink discharge nozzle row 14i. In addition, an ink cartridge 95 for supplying the UV ink to the ink jet head 55 is mounted on the supporting member 105.

The head unit 45 is configured with the supporting member 105, the ink jet head 55, and the ink cartridge 95.

On the downstream side in the transport direction HY2 of the head unit 45, a UV light source 125 supported by a supporting member 115 is disposed. The UV light source 125 is disposed such that an irradiated surface 125a irradiated with the UV light opposes the transport belt 71a. The irradiated surface 125a extends in the direction TY2 orthogonal to the transport direction HY2 of the printing medium 3.

In addition, in the present embodiment, an ink discharge nozzle row 14i corresponds to a first ink discharge nozzle row since the ink discharge nozzle row 14i discharges the white ink as the background image printing UV ink. Further, the ink discharge nozzle row 141 corresponds to a second ink discharge nozzle row since the ink discharge nozzle row 141 discharges the cyan, magenta, yellow, and black UV inks as the main image printing UV ink. In addition, the UV light source 125 corresponds to a first UV light source since the UV light source 125 is a UV light source that cures the background image printing UV ink. Further, the UV light source 129 corresponds to a second UV light source since the UV light source 129 is a UV light source that cures the main image printing UV.

Here, a gap (space) between the ink discharge surface 89 and the transport belt 71a, or the gap (space) between the ink discharge surface 82 and the printing medium 3 also corresponds to a platen gap. In addition, in FIG. 11, the ink discharge surface 89 is a surface including the ink discharge surfaces 80 to 85.

The plasma actuator 20 is disposed between the ink discharge nozzle row 14i and the irradiated surface 125a of the UV light source 125. The plasma actuator 20 is formed longer than at least one of the length of the ink discharge nozzle row 14i and the length of the irradiated surface 125a in the direction TY2. By doing so, the mist of the UV ink generated from the ink discharge nozzle row 14i becomes unlikely to adhere to the irradiated surface 125a, and it is possible to reduce occurrence of irradiation failure of the UV light source 120 due to the mist of the UV ink. In addition, as illustrated in FIG. 11, the plasma actuator 20 is disposed to generate the airflow in the discharge direction IY2 of the UV ink. In other words, the two thin film electrodes 21a and 21b of the plasma actuator 20 and the dielectric layer 22 interposed between the electrodes 21a and 21b are disposed in the gap between the UV light source 125 and the plasma actuator 20 in FIG. 11. In addition, the two thin film electrodes 21a and 21b of the plasma actuator 20 and the dielectric layer 22 interposed between the electrodes 21a and 21b may be disposed in the gap between the ink jet head 55 and the plasma actuator 20, or may be disposed in the both gaps. In the present embodiment, the plasma actuator 20 is supported by the supporting member 105. In addition, the support of the plasma actuator 20 may be supported, for example, by being fitted to the ink jet head 55, and may be any support as long as the support is disposed between the ink discharge nozzle row 14i and the irradiated surface 125a of the UV light source 125.

Here, a printing operation of the printing apparatus 1a illustrated in FIG. 11 will be described.

The printing apparatus 1a discharges the UV ink from the ink discharge nozzle row 14i and prints the background image on the printing medium 3 before discharging the UV ink from the ink discharge nozzle row 141 and printing the main image on the printing medium 3. The printing apparatus 1a performs the temporary curing by the UV light source 125 when the UV ink is discharged from the ink discharge nozzle row 14i. In addition, as described above, the printing apparatus 1a performs the temporary curing while discharging the UV ink from the ink discharge nozzle row 141, performs the main curing when the entire temporary curing is completed, and prints the main image superimposing the main image on the background image.

As described above, in the printing method, there is a case where the mist of the UV ink is generated and adheres to the irradiated surface 125a of the UV light source 125 and the irradiated surface 129a of the UV light source 129, and the adhered mist is cured on the irradiated surface 125a and the irradiated surface 129a.

In addition, as described above, when the mist of the UV ink is cured on the irradiated surface 125a and the irradiated surface 129a, the amount of UV light emitted from the UV light source 125 and the UV light source 129 decreases, and there is a possibility that the UV ink discharged onto the printing medium 3 is not be appropriately cured. In particular, when printing the background image, since the background image printing UV ink is discharged to the entire printing region of the printing medium 3, the mist of the background image printing UV ink is generated more than the mist of the main image printing UV ink. Therefore, in the UV light source 125 that cures the background image printing UV ink, there is a high probability that the amount of the emitted UV light decreases due to the mist of the UV ink more than that in the UV light source 129 that cures the main image printing UV ink. In addition, since the mist of the background image printing UV ink is generated more than the mist of the main image printing UV ink, there is a high probability that the mist of the background image printing UV ink also adheres to the irradiated surface 129a of the UV light source 129 disposed on the downstream side in the transport direction HY2 of the ink discharge nozzle row 14i.

Here, the plasma actuator 20 is disposed as illustrated in FIGS. 11 and 12. In other words, the plasma actuator 20 is disposed between the ink discharge nozzle row 14i and the UV light source 125, and between the ink discharge nozzle row 141 and the UV light source 129. Since the plasma actuator 20 is disposed in this manner, it is possible to generate the airflow between the ink discharge nozzle row 14i and the UV light source 125 and between the ink discharge nozzle row 141 and the UV light source 129. Therefore, it is possible to suppress the adhesion of the mist of the UV ink discharged from the ink discharge nozzle row 14i to the irradiated surface 125a of the UV light source 125, and to suppress the adhesion of the mist of the UV ink discharged from the ink discharge nozzle row 141 to the irradiated surface 129a of the UV light source 129. Therefore, the printing apparatus 1a can reduce the occurrence of irradiation failure of the UV light source 125 and the UV light source 129 due to the mist of the UV ink.

In addition, as illustrated in FIG. 11, the plasma actuator 20 generates the airflow in the discharge direction IY2 of the ink. Since the plasma actuator 20 is disposed in this manner, the air curtain is formed between the ink discharge nozzle row 14i and the UV light source 125 and between the ink discharge nozzle row 141 and the UV light source 129. Therefore, it is possible to suppress the flow of the mist of the UV ink to the downstream side in the transport direction HY2. Therefore, the mist of the UV ink discharged from the ink discharge nozzle row 14i becomes unlikely to adhere to the irradiated surface 125a of the UV light source 125, and the mist of the UV ink discharged from the ink discharge nozzle row 141 becomes unlikely to adhere to the irradiated surface 129a of the UV light source 129. Therefore, the printing apparatus 1a can reduce the occurrence of irradiation failure of the UV light source 125 and the UV light source 129 due to the mist of the UV ink. In addition, since the plasma actuator 20 is disposed such that the airflow is generated in the discharge direction IY2 of the UV ink, it is possible to suppress disturbance of the landing position of the UV ink due to the transport of the printing medium 3.

In addition, since the background image is often printed in a wider range than the main image, the discharge amount of the background image printing UV ink is often larger than the discharge amount of the main image printing UV ink. Therefore, the airflow of the plasma actuator 20 disposed between the ink discharge nozzle row 14i and the UV light source 125 is set to have a larger air volume than that of the airflow of the plasma actuator 20 disposed between the ink discharge nozzle row 141 and the UV light source 129.

Accordingly, it is possible to further suppress the flow of the mist of UV ink discharged from the ink discharge nozzle row 14i to the downstream side in the transport direction HY2 of the printing medium 3. As described above, the mist of the UV ink discharged from the ink discharge nozzle row 14i is generated more than the mist of the main image printing UV ink. Therefore, there is a high probability that the mist of the UV ink discharged from the ink discharge nozzle row 14i adheres to the irradiated surface of the UV light source 125 and the UV light source 129 which are disposed on the downstream side in the transport direction HY2 of the ink discharge nozzle row 14i. Here, the airflow of the plasma actuator 20 disposed between the ink discharge nozzle row 14i and the UV light source 125 is set to have a larger air volume than that of the airflow of the plasma actuator 20 disposed between the ink discharge nozzle row 141 and the UV light source 129. Therefore, it is possible to suppress the adhesion of the mist of the UV ink discharged from the ink discharge nozzle row 14i to the irradiated surface of the UV light source 125 and the UV light source 129. Therefore, similar to the background image printing UV ink, even in a case where a large amount of mist is generated, it is possible to reduce occurrence of irradiation failure of the UV light source 125 and the UV light source 129 due to the mist of the UV ink.

Here, it is considered that the air volume of the airflow of the plasma actuator 20 disposed between the ink discharge nozzle row 141 and the UV light source 129 is set to be large in accordance with the air volume of the airflow of the plasma actuator 20 disposed between the ink discharge nozzle row 14i and the UV light source 125. However, as described above, since the plasma actuator 20 requires a high voltage to drive, when the air volume of the airflow of the plasma actuator 20 disposed between the ink discharge nozzle row 14i and the UV light source 125 and the air volume of the airflow of the plasma actuator 20 disposed between the ink discharge nozzle row 141 and the UV light source 129 are set to be the same as each other, there is a concern regarding the power consumption. In the present embodiment, by setting the airflow of the plasma actuator 20 disposed between the ink discharge nozzle row 14i and the UV light source 125 to be larger than the airflow of the plasma actuator 20 disposed between the ink discharge nozzle row 141 and the UV light source 129, after suppressing the power consumption, it is possible to reduce occurrence of the irradiation failure of the UV light source 125 and the UV light source 129 due to the mist of the UV ink.

Next, a modification example of disposition of the plasma actuators 20 will be described.

In the present modification example, it is assumed that there is no gap between each of the ink jet heads 51 to 53 and the ink jet head 55 and the plasma actuator 20 and between each of the UV light sources 120 to 123 and the UV light source 125 and the plasma actuator 20. In other words, it is not possible to dispose the electrodes as illustrated in FIGS. 9 and 11.

Here, in the present modification example, as illustrated in FIGS. 5 and 6, the plasma actuators 20 are disposed two by two between the ink discharge nozzle row 14i and the irradiated surface 125a of the UV light source 125, between the ink discharge nozzle row 14e and the irradiated surface 120a of the UV light source 120, between the ink discharge nozzle row 14f and the irradiated surface 121a of the UV light source 121, between the ink discharge nozzle row 14g and the irradiated surface 122a of the UV light source 122, and between the ink discharge nozzle row 14h and the irradiated surface 123a of the UV light source 123 such that the airflows are generated in directions facing each other.

By disposing each of the plasma actuators 20 in this manner, since the airflows facing each other collide with each other between the two plasma actuators 20, it is possible to generate the airflow in the discharge direction IY1 in which the UV ink is discharged. Therefore, even in a case where the plasma actuator 20 is disposed as illustrated in the present modification example, the same effects as those described above can be obtained.

The functional configuration of the printing apparatus 1a in the present embodiment is the same as the configuration except for the carriage driver 33 and the carriage motor 37 in FIG. 8.

Therefore, the printing apparatus 1a includes the driving voltage generation unit 39 for driving the plasma actuator 20. In the present embodiment, the driving voltage generation unit 39 is mounted on each of the head units 40 to 43, the UV light source unit 44, and the head unit 45. When being mounted on the head units 40 to 43 and the head unit 45, the driving voltage generation unit 39 is supported by, for example, each of the supporting members that support the ink jet head. Further, in a case of being mounted on the UV light source unit 44, the driving voltage generation unit 39 is supported by the supporting member 114, for example.

In addition, the driving voltage generation unit 39 mounted on the head unit 40 to the head unit 43 and the head unit 45 may configure the UV light source unit together with the corresponding UV light source and may be mounted on the UV light source unit.

The head units 40 to 43, the UV light source unit 44, and the head unit 45 are provided with the flexible cable for transmitting the head driving signal. Additionally laying a high voltage wiring for driving the plasma actuator 20 in the flexible cable is not preferable because problems, such as insulation distance, short-circuiting measures, noise countermeasure, and the like, occur. Here, in the present embodiment, the low voltage power source supply line is disposed in the flexible cable, and the driving voltage generation unit 39 is mounted on the head units 40 to 43, the UV light source unit 44, and the head unit 45. The driving voltage generation unit 39 takes the constant voltage power source as an input voltage and boosts the voltage to a high voltage in the head units 40 to 43, the UV light source unit 44, and the head unit 45.

In this manner, since the driving voltage generation unit 39 is mounted on the head units 40 to 43, the UV light source unit 44, and the head unit 45, it is possible to generate the driving voltage to the plasma actuator 20 driven with a high voltage by the driving voltage generation unit 39. Therefore, it is unnecessary to lay the high voltage wiring in the flexible cable in the head units 40 to 43, the UV light source unit 44, and the head unit 45, and problems, such as insulation, short-circuiting measures, noise countermeasure, and the like, do not occur.

As described above, the printing apparatus 1a of the present embodiment includes the ink jet heads 50 to 53 provided with the ink discharge nozzle row 141 that extends in the direction TY2 (intersecting direction) orthogonal to the transport direction HY2 of the printing medium 3.

Accordingly, in the printing apparatus 1a including the ink jet heads 50 to 53 having the ink discharge nozzle row 141 that extends in the direction TY2, since the plasma actuator 20 generates the airflow in the direction away from the irradiated surface of the UV light source 129, the mist of the UV ink becomes unlikely to adhere to the irradiated surface 129a of the UV light source 129, and it is possible to reduce occurrence of the irradiation failure of the UV light source 129 due to the mist of the UV ink.

In addition, the plasma actuator 20 is disposed side by side with the ink discharge nozzle row 141 in the transport direction HY2 of the printing medium 3.

Accordingly, since the plasma actuator 20 is disposed side by side with the ink discharge nozzle row 141 in the transport direction HY2 of the printing medium 3, the mist of the UV ink discharged from the ink discharge nozzle row 141 disposed in the transport direction HY2 becomes unlikely to adhere to the irradiated surface 129a of the UV light source 129. Therefore, the printing apparatus 1a can reduce the occurrence of irradiation failure of the UV light source 129 due to the mist of the UV ink.

In addition, the plasma actuator 20 generates the airflow in the discharge direction IY2 in which the ink discharge nozzle row 141 discharges the UV ink.

Accordingly, since the plasma actuator 20 generates the airflow in the discharge direction IY2 in which the ink discharge nozzle row 141 discharges the UV ink, the air curtain is formed between the ink discharge nozzle row 141 and the UV light source 129, the mist of the UV ink becomes unlikely to adhere to the irradiated surface 129a of the UV light source 129, and it is possible to reduce occurrence of the irradiation failure of the UV light source 125 due to the mist of the UV ink.

In addition, the printing apparatus 1a includes the ink discharge nozzle row 14i (first ink discharge nozzle row) for discharging the background image printing UV ink for printing the background image as the ink discharge nozzle row, and the ink discharge nozzle row 141 (second ink discharge nozzle row) for discharging the main image printing UV ink for printing the main image. In addition, the printing apparatus 1a includes the UV light source 125 (first UV light source) for curing the background image printing UV ink and the UV light source 129 (second UV light source) for curing the main image printing UV ink, as the UV light source. In addition, the plasma actuator 20 is disposed between the ink discharge nozzle row 14i and the UV light source 125, and between the ink discharge nozzle row 141 and the UV light source 129.

In this manner, the plasma actuator 20 is disposed between the ink discharge nozzle row 14i and the UV light source 125, and between the ink discharge nozzle row 141 and the UV light source 129. Therefore, the mist of the background image printing UV ink becomes unlikely to adhere to the irradiated surface 125a of the UV light source 125, the mist of the main image printing UV ink becomes unlikely to adhere to the irradiated surface 129a of the UV light source 129, and it is possible to reduce occurrence of irradiation failure of the UV light source 125 and the UV light source 129 due to the mist of each UV ink.

In addition, the plasma actuator 20 disposed between the ink discharge nozzle row 14i and the UV light source 125 generates an airflow having a larger air volume than that of the airflow generated by the plasma actuator 20 disposed between the ink discharge nozzle row 141 and the UV light source 129.

Accordingly, it is possible to suppress the adhesion of the mist of the UV ink discharged from the ink discharge nozzle row 14i to the irradiated surface of the UV light source 125 and the UV light source 129. Therefore, similar to the background image printing UV ink, even in a case where a large amount of mist is generated, it is possible to reduce occurrence of irradiation failure of the UV light source 125 and the UV light source 129 due to the mist of the UV ink.

In addition, the printing apparatus 1a includes head units 40 to 43 having the driving voltage generation unit 39 and the ink discharge nozzle row 141. In addition, the printing apparatus 1a includes the head unit 45 having the driving voltage generation unit 39 and the ink discharge nozzle row 14i.

Accordingly, it is possible to generate the driving voltage to the plasma actuator 20 driven with a high voltage by the driving voltage generation unit 39. Therefore, it is unnecessary to lay the high voltage wiring in the flexible cable in the head units 40 to 43 and the head unit 45, and problems, such as insulation, short-circuiting measures, noise countermeasure, and the like, do not occur.

In addition, the printing apparatus 1a includes the UV light source unit 44 having the driving voltage generation unit 39 and the UV light source 124.

Accordingly, it is possible to generate the driving voltage to the plasma actuator 20 driven with a high voltage by the driving voltage generation unit 39. Therefore, it is unnecessary to lay the high voltage wiring in the flexible cable disposed in the UV light source unit 44, and problems, such as insulation, short-circuiting measures, noise countermeasures, and the like, do not occur.

In addition, in the present embodiment, the ink jet heads 51 to 55 are described as extending in the direction orthogonal to the transport direction HY2, but may not be necessarily orthogonal. The nozzle row may be disposed to cover the printing region of the printing medium 3.

In addition, in the present embodiment, a case where the plasma actuator 20 generates the airflow in the discharge direction IY2 of the UV ink has been exemplified, but when it is possible to suppress the adhesion of the mist of the UV ink to the irradiated surface 125a of the UV light source 125 and the irradiated surface 129a of the UV light source 129, the direction in which the airflow is generated is not limited to the discharge direction IY2 of the UV ink.

For example, the plasma actuator 20 disposed between the ink discharge nozzle row 141 and the UV light source 129 may be configured to generate the airflow in the direction opposite to the transport direction HY2 of the printing medium 3. Accordingly, it is possible to suppress the adhesion of the mist of the UV ink discharged from the ink discharge nozzle row 141 to the irradiated surface 129a of the UV light source 129.

In addition, for example, the plasma actuator 20 disposed between the ink discharge nozzle row 14i and the UV light source 125 may be configured to generate the airflow in the direction opposite to the transport direction HY2 of the printing medium 3. Accordingly, it is possible to suppress the adhesion of the mist of the UV ink discharged from the ink discharge nozzle row 14i to the irradiated surface 125a of the UV light source 125.

Further, the configurations may be combined with each other.

The directions of the airflow also correspond to the direction away from the irradiated surface of the UV light source.

### Third Embodiment

Next, a third embodiment will be described.

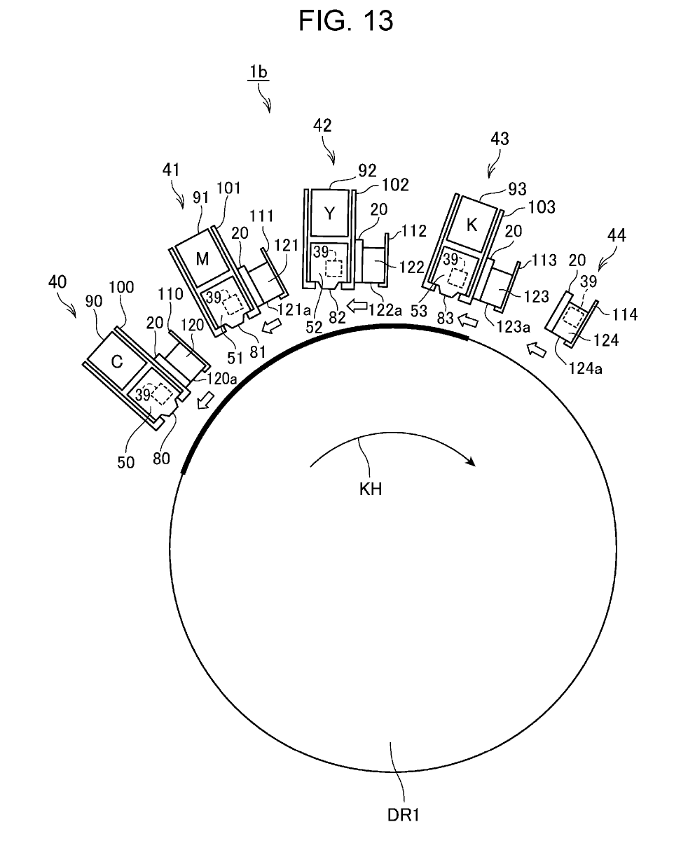

FIG. 13 is a view illustrating an outline of a printing apparatus 1b according to the third embodiment. The same part as that in the printing apparatus 1b according to the second embodiment will be given the same reference numerals, and the detailed description thereof will be omitted.

As can be apparent by comparing to the printing apparatus 1a according to the second embodiment, the printing apparatus 1b according to the third embodiment includes a rotary drum DR1, and transports the printing medium 3 in a rotational direction KH of the drum DR1 according to the rotation of the drum DR1.

Further, in the printing apparatus 1b according to the third embodiment, in order from the upstream side in the rotational direction KH, the head unit 40, the head unit 41, the head unit 42, the head unit 43, and the UV light source unit 44 are disposed.

The head unit 40 is disposed such that the ink discharge surface 80 opposes the surface of the drum DR1. On the ink discharge surface 80, the ink discharge nozzle row 14e is formed. In addition, the head unit 41 is disposed such that the ink discharge surface 81 opposes the surface of the drum DR1. On the ink discharge surface 81, the ink discharge nozzle row 14f is formed. In addition, the head unit 42 is disposed such that the ink discharge surface 82 opposes the surface of the drum DR1. On the ink discharge surface 82, the ink discharge nozzle row 14g is formed. In addition, the head unit 43 is disposed such that the ink discharge surface 83 opposes the surface of the drum DR1. Further, the UV light source unit 44 is disposed such that the ink discharge surface 83 opposes the surface of the drum DR1. On the ink discharge surface 83, the ink discharge nozzle row 14h is formed.

In the present embodiment, the gap (space) between the ink discharge surface 80 and the surface of the drum DR1 opposing the ink discharge surface 80, or the gap (space) between the ink discharge surface 80 and the printing medium 3 also corresponds to the platen gap. In addition, the gap (space) between the ink discharge surface 81 and the surface of the drum DR1 opposing the ink discharge surface 82, or the gap (space) between the ink discharge surface 81 and the printing medium 3 also corresponds to the platen gap. In addition, the gap (space) between the ink discharge surface 82 and the surface of the drum DR1 opposing the ink discharge surface 82, or the gap (space) between the ink discharge surface 82 and the printing medium 3 also corresponds to the platen gap. In addition, the gap (space) between the ink discharge surface 83 and the surface of the drum DR1 opposing the ink discharge surface 83, or the gap (space) between the ink discharge surface 83 and the printing medium 3 also corresponds to the platen gap.

In the printing apparatus 1b according to the third embodiment, the head units 40 to 43 performs the UV ink discharge and the temporary curing by the head units 40 to 43 with respect to the printing medium 3 transported in the rotation direction KH, and performs the main curing by the UV light source unit 44.

In a case of the printing apparatus 1b which transports the printing medium 3 by the drum DR1, the plasma actuator 20 is disposed between the ink discharge nozzle row 141 and the UV light source 129. In addition, the plasma actuator 20 generates the airflow in the direction opposite to the rotational direction of the drum DR1.

By the rotation of the drum DR1, there is a case where the airflow is generated in the rotational direction KH in the platen gap due to the rotation. Therefore, there is case where the mist of the UV ink discharged from each of the head units 40 to 43 flows in the rotational direction KH of the drum DR1 and adheres to the irradiated surface 129a of the UV light source 129 positioned on the downstream side in the rotational direction KH. However, since the plasma actuator 20 is disposed between the ink discharge nozzle row 141 and the UV light source 129, it is possible to suppress the adhesion of the mist of the UV ink to the irradiated surface 129a of the UV light source 129, and it is possible to reduce occurrence of the irradiation failure of the UV light source 129 due to the UV ink.

In addition, the plasma actuator 20 generates the airflow in the direction opposite to the rotational direction of the drum DR1. Accordingly, it is possible to suppress the airflow in the rotational direction KH caused by the rotation of the drum DR1 in the platen gap, and to suppress the flow of the mist of the UV ink to the UV light source 129. In other words, the printing apparatus 1b can suppress the adhesion of the mist of the UV ink to the irradiated surface 129a of the UV light source 129, and it is possible to reduce occurrence of irradiation failure of the UV light source 129 due to the mist of the UV ink.

The direction opposite to the rotational direction KH also corresponds to the direction away from the irradiated surface of the UV light source.

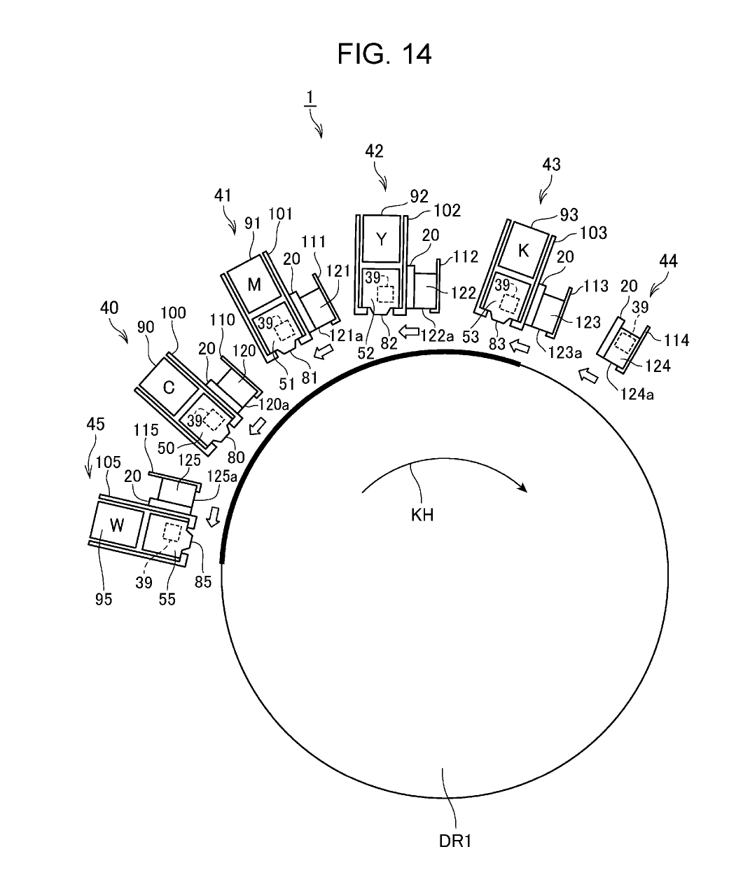

FIG. 14 is a view illustrating an outline of the printing apparatus 1b according to the third embodiment for discharging the background image printing UV ink. In FIG. 14, the same parts as those in FIGS. 11 and 13 will be given the same reference numerals, and the detailed description thereof will be omitted.

In a case of discharging the background image printing UV ink, in the printing apparatus 1b, the head unit 45 is disposed on the upstream side in the rotational direction KH of the head unit 40.

The head unit 45 is disposed such that the ink discharge surface 85 opposes the surface of the drum DR1. On the ink discharge surface 85, the ink discharge nozzle row 14i is formed.

Here, the gap (space) between the ink discharge surface 85 and the surface of the drum DR1 opposing the ink discharge surface 85, or the gap (space) between the ink discharge surface 85 and the printing medium 3 also corresponds to the platen gap.

In a case of the printing apparatus 1b illustrated in FIG. 14, the plasma actuator 20 is disposed between the ink discharge nozzle row 14i and the UV light source 125, and between the ink discharge nozzle row 141 and the UV light source 129. In addition, each of the plasma actuators 20 generates the airflow in the direction opposite to the rotational direction KH of the drum DR1.

In this manner, the plasma actuator 20 is disposed to generate the airflow in the direction opposite to the rotational direction KH of the drum DR1. Accordingly, even in a case where the printing apparatus 1b is provided with the rotary drum DR1 and discharges the background image printing UV ink, the same effect as the effect described in the second embodiment is exerted.

The functional configuration of the printing apparatus 1b in the present embodiment is the same as the configuration except for the carriage driver 33 and the carriage motor 37 in FIG. 8.

Therefore, the printing apparatus 1b includes the driving voltage generation unit 39 for driving the plasma actuator 20. In the present embodiment, the driving voltage generation unit 39 is mounted on each of the head units 40 to 43, the UV light source unit 44, and the head unit 45. When being mounted on the head units 40 to 43 and the head unit 45, the driving voltage generation unit 39 is supported by, for example, each of the supporting members that support the ink jet head. Further, in a case of being mounted on the UV light source unit 44, the driving voltage generation unit 39 is supported by the supporting member 114, for example.

In addition, the driving voltage generation unit 39 mounted on the head unit 40 to the head unit 43 and the head unit 45 may configure the UV light source unit together with the corresponding UV light source and may be mounted on the UV light source unit.

At least the head units 40 to 43, the UV light source unit 44, and the head unit 45 are provided with the flexible cable for transmitting the head driving signal. Additionally laying a high voltage wiring for driving the plasma actuator 20 in the flexible cable is not preferable because problems, such as insulation distance, short-circuiting measures, noise countermeasure, and the like, occur. Therefore, in the present embodiment, the low voltage power source supply line is disposed in the flexible cable, and the driving voltage generation unit 39 is mounted on the head units 40 to 43, the UV light source unit 44, and the head unit 45. The driving voltage generation unit 39 takes the constant voltage power source as an input voltage and boosts the voltage to a high voltage in the head units 40 to 43, the UV light source unit 44, and the head unit 45.

In this manner, since the driving voltage generation unit 39 is mounted on the head units 40 to 43, the UV light source unit 44, and the head unit 45, it is possible to generate the driving voltage to the plasma actuator 20 driven with a high voltage by the driving voltage generation unit 39. Therefore, it is unnecessary to lay the high voltage wiring in the flexible cable in the head units 40 to 43, the UV light source unit 44, and the head unit 45, and problems, such as insulation, short-circuiting measures, noise countermeasure, and the like, do not occur.

In addition, in the present embodiment, a case where the plasma actuator 20 generates the airflow in the direction opposite to the rotational direction KH of the drum DR1 has been exemplified, but when it is possible to suppress the adhesion of the UV ink to the irradiated surfaces of the UV light source 129 and the UV light source 125, the configuration is not limited to the configuration in which the airflow is generated in the direction opposite to the rotational direction KH of the drum DR1. For example, the airflow generated by the plasma actuator 20 may be a surface direction of the drum DR1. Even in this direction, it is possible to suppress the flow of the mist of the UV ink in the rotational direction KH of the drum DR1, and thus, it is possible to reduce occurrence of irradiation failure of the UV light source 129 and the UV light source 125 due to the mist of the UV ink.

The direction of the airflow also corresponds to the direction away from the irradiated surface of the UV light source.

Further, in the present embodiment, a configuration in which, in the vicinity of one drum DR1, from the upstream side in the rotational direction KH, the head unit 45, the head units 40 to 43, and the UV light source unit 44 are disposed, has been exemplified. However, the drum on which the head unit 45 is disposed and the drum on which the head units 41 to 43 and the UV light source unit 44 are disposed may be different. In this case, in the printing apparatus 1b, in order from the upstream side in the transport direction of the printing medium 3, the drum on which the head unit 45 is disposed, the head units 40 to 43, and the drum on which the UV light source unit 44 is disposed are disposed.

As described above, the printing apparatus 1b includes the rotary drum DR1 that transports the printing medium 3. The plasma actuator 20 generates the airflow in the direction opposite to the rotational direction KH in which the drum DR1 rotates.

Accordingly, in the configuration in which the printing apparatus 1b includes the drum DR1, since the plasma actuator 20 generates the airflow in the direction opposite to the rotational direction KH in which the drum DR1 rotates, the mist of the UV ink becomes unlikely to adhere to the irradiated surface of the UV light source 125 and the UV light source 129, and it is possible to reduce occurrence of the irradiation failure of the UV light source 125 and the UV light source 129 due to the mist of the UV ink.

Each of the above-described embodiments merely illustrate one aspect of the present invention, and any modifications and applications are possible within the scope of the present invention.

For example, in the above-described first embodiment, a configuration in which the printing apparatus 1 discharges the cyan, magenta, yellow, and black UV inks onto the printing medium 3 and prints the image on the printing medium 3 has been exemplified. However, similar to the printing apparatus 1a in the second embodiment and the printing apparatus 1b in the third embodiment, the printing apparatus 1 in the first embodiment may also be configured to print the background image on the printing medium 3. In this case, the ink jet head for discharging the background image printing UV ink and the UV light source for curing the background image printing UV ink are mounted on the head unit 16. In addition, the plasma actuator 20 is appropriately disposed such that the adhesion of the mist of the background image printing ink to the irradiated surface of the UV light source can be suppressed. In addition, the ink jet head for discharging the background image printing UV ink and the UV light source for curing the background image printing UV ink may be integrated with the ink jet head 11.

In addition, in each of the above-described embodiments, a case of superimposing and printing the main image after printing the background image in order to print a printed material that is visually recognized from the printing surface side has been described, but there is also a case of superimposing and printing the background image after printing the main image first in order to print the printed material that is visually recognized from the side opposite to the printing surface. In this case, a nozzle row for printing the main image is disposed on the upstream side in the moving direction of the carriage 10 or in the transport direction of the printing medium 3, and the nozzle row for printing the background image is disposed on the downstream side. In other words, only the disposition order of each head unit differs in FIGS. 11 to 14, there is no difference in the fact that the plasma actuator 20 is provided in the downstream direction of the irradiated surface of the UV light source, and it is needless to say that the same operational effects as those described in the present embodiment are achieved.

Further, in the above-described second embodiment, it is described that the air volume of the airflow generated by the plasma actuator 20 that corresponds to the mist of the background image UV ink is larger than the airflow generated by the plasma actuator 20 that corresponds to the mist of the main image UV ink. It is needless to say that similar configurations can also be applied to the printing apparatus 1 of the first embodiment and the printing apparatus 1b of the third embodiment which are described above, and the same operational effects can be achieved.

Further, for example, a configuration in which the printing apparatus 1a according to the second embodiment and the printing apparatus 1b according to the third embodiment which are described above respectively include the head units 40 to 43 and the UV light source unit 44 which are separated from each other has been exemplified. However, the head units 40 to 43 and the UV light source unit 44 may be configured as an integral unit. Further, a configuration in which the printing apparatus 1a according to the second embodiment and the printing apparatus 1b according to the third embodiment which are described above respectively include the head units 40 to 43, the UV light source unit 44, and the head unit 45 which are separated from each other has been exemplified. However, the head units 40 to 43, the UV light source unit 44, and the head unit 45 may be configured as an integral unit.

Further, for example, in each of the above-described embodiments, the white UV ink is exemplified as the background image printing UV ink. However, the background image printing UV ink is not limited to the white UV ink, but may be, for example, metallic UV ink or may be UV ink used for printing the background image. In addition, as the main image printing UV ink, the cyan, magenta, yellow, and black UV inks have been exemplified. However, the main image printing UV ink is not limited to the UV inks, but may be, for example, UV ink used in printing the main image to be superimposed and printed on the background image. In addition, the printing apparatuses 1a and 1b may be configured to discharge clear (transparent) UV ink. In this case, the printing apparatuses 1a and 1b have an ink discharge nozzle row for discharging the clear UV ink. In addition, the printing apparatuses 1a and 1b have a UV light source that cures the clear UV ink in a case where the ink jet head having the ink discharge nozzle row is a line type ink jet head.

In addition, each functional unit illustrated in FIG. 8 indicates a functional configuration, and a specific embodiment is not particularly limited. In other words, it is not always necessary to mount hardware that corresponds to each functional unit individually, and it is needless to say that the function of a plurality of functional units is realized by executing a program by one processor. In addition, some of the functions realized by software in each of the above-described embodiments may be realized by hardware, or some of the functions realized by hardware may be realized by software. In addition, specific detailed configurations of the other parts of the printing apparatuses 1, 1a, and 1b can be changed in any manner without departing from the spirit of the present invention.

### REFERENCE SIGNS LIST

printing apparatus
1a printing apparatus
1b printing apparatus
3 printing medium
10 carriage
11 ink jet head
12 UV light source
12a irradiated surface
13 UV light source
13a irradiated surface
14 ink discharge nozzle row
14a to 14i ink discharge nozzle row
16 head unit
20 plasma actuator
39 driving voltage generation unit
40 to 43 head unit
44 UV light source unit
45 head unit
50 to 55 ink jet head
89 ink discharge surface
120 to 125 UV light source
120a to 125a irradiated surface
129 UV light source
129a irradiated surface
141 ink discharge nozzle row
DR1 drum

1. A printing apparatus comprising:
an ink discharge nozzle row for discharging a UV ink;
a UV light source for emitting a UV light for curing the UV ink; and
a plasma actuator that generates an airflow in a direction away from an irradiated surface of the UV light source.

2. The printing apparatus according to claim 1, wherein
the plasma actuator is disposed between the ink discharge nozzle row and the UV light source.

3. The printing apparatus according to claim 1, further comprising:
an ink jet head that is mounted on a carriage that reciprocates in a direction intersecting with a transport direction of a printing medium and has the ink discharge nozzle row.

4. The printing apparatus according to claim 3, wherein
the plasma actuator is disposed side by side with the ink discharge nozzle row in a moving direction of the carriage.

5. The printing apparatus according to claim 3, further comprising:
a plurality of the plasma actuators that are disposed to interpose the ink discharge nozzle row therebetween.

6. The printing apparatus according to claim 3, wherein
the plasma actuator generates the airflow in a discharge direction in which the ink discharge nozzle row discharges the UV ink.

7. The printing apparatus according to claim 1, further comprising:
an ink jet head having the ink discharge nozzle row that extends in a direction intersecting with a transport direction of a printing medium.

8. The printing apparatus according to claim 7, wherein
the plasma actuator is disposed side by side with the ink discharge nozzle row in the transport direction of the printing medium.

9. The printing apparatus according to claim 7, wherein
the plasma actuator generates the airflow in a discharge direction in which the ink discharge nozzle row discharges the UV ink.

10. The printing apparatus according to claim 7, further comprising:
a rotary drum for transporting the printing medium, wherein
the plasma actuator generates the airflow in a direction opposite to a rotational direction in which the drum rotates.

11. The printing apparatus according to claim 1, wherein
the ink discharge nozzle row includes a first ink discharge nozzle row for discharging a background image printing UV ink for printing a background image and a second ink discharge nozzle row for discharging a main image printing UV ink for printing a main image, wherein
the UV light source includes a first UV light source for curing the background image printing UV ink and a second UV light source for curing the main image printing UV ink, and wherein
the plasma actuator is disposed between the first ink discharge nozzle row and the first UV light source and between the second ink discharge nozzle row and the second UV light source.

12. The printing apparatus according to claim 11, wherein
the plasma actuator disposed between the first ink discharge nozzle row and the first UV light source generates the airflow having a larger air volume than that of the airflow generated by the plasma actuator disposed between the second ink discharge nozzle row and the second UV light source.

13. The printing apparatus according to claim 11, further comprising:
a head unit having a driving voltage generation unit that generates a driving voltage for driving the plasma actuator, and the ink discharge nozzle row.

14. The printing apparatus according to claim 11, further comprising:
a UV light source unit having a driving voltage generation unit that generates a driving voltage for driving the plasma actuator, and the UV light source.

15. The printing apparatus according to claim 11, wherein
a length of the plasma actuator is longer than a length of the irradiated surface of the UV light source.

16. The printing apparatus according to claim 11, wherein
the length of the plasma actuator is longer than a length of the ink discharge nozzle row.

17. A head unit comprising:
an ink discharge nozzle row for discharging a UV ink;
